(19) United States
(12) Patent Application Publication
(10) Pub. No.: US 2010/0008109 A1
(43) Pub. Date: Jan. 14, 2010

(54) SWITCHING POWER SUPPLY AND SEMICONDUCTOR DEVICE FOR SWITCHING POWER SUPPLY

(75) Inventor: Naohiko Morota, Hyogo (JP)

Correspondence Address: STEPTOE & JOHNSON LLP, 1330 CONNECTICUT AVE., NW, WASHINGTON, DC, 20036, US

(73) Assignee: Panasonic Corporation, Osaka (JP)

(21) Appl. No.: 12/499,114

(22) Filed: Jul. 8, 2009

(30) Foreign Application Priority Data
Jul. 10, 2008 (JP) 2008-179657

(51) Int. Cl. H02M 3/335

(52) U.S. Cl. 363/21.16

(57) ABSTRACT

A switching power supply of the present invention includes: an oscillator circuit for oscillating a signal for turning on a switching element; an error signal generating circuit for generating an error signal having a signal level corresponding to a difference between the signal level of a feedback signal and a reference level; a switching control circuit for turning on the switching element at a time in response to the signal oscillated by the oscillator circuit and turning off the switching element at a time in response to the signal level of the error signal; and a reference level control circuit for controlling the reference level according to a time period during which the switching operation of the switching element is stopped.

### FIELD OF THE INVENTION

The present invention relates to a switching power supply and a semiconductor device for the switching power supply.

### BACKGROUND OF THE INVENTION

In recent years, size reduction and higher power conversion efficiency have been demanded of power supplies of electronic equipment. In response to these demands, switching power supplies have been widely used. In a switching power supply, DC power is generated by rectifying and smoothing commercial AC power, the DC power is converted to high-frequency power by the switching operation of a semiconductor element having a high withstand voltage, and the high-frequency power is transferred by a small-size power conversion transformer. After that, the switching power supply obtains a low-voltage DC power by rectifying and smoothing the high-frequency power having been transferred by the power conversion transformer.

Further, against the backdrop of worldwide growing awareness of energy conservation, lower standby power consumption has been demanded of electronic equipment. In response to this demand, techniques for reducing standby power consumption with switching power supplies have been developed.

In a switching power supply, the input side and the output side are electrically insulated from each other by a power conversion transformer to ensure safety. Hereinafter, the input side may be referred to as a primary side and the output side may be referred to as a secondary side. In a typical switching power supply, an output voltage Vo on the secondary side is detected by a secondary-side output voltage detection circuit provided on the secondary side, a detection signal from the secondary-side output voltage detection circuit is transferred from the secondary side to the primary side through a photocoupler, and constant voltage control is performed on the output voltage Vo by using the transferred signal.

However, the secondary-side output voltage detection circuit and the photocoupler are expensive power supply components and interfere with size reduction of switching power supplies. Thus in known switching power supplies of the prior art, the expensive power supply components are omitted and auxiliary windings are provided instead on the primary sides of power conversion transformers. Such switching power supplies are called auxiliary winding feedback type.

An auxiliary winding generates a voltage in proportion to a voltage generated on the secondary winding of a power conversion transformer. In a switching power supply of the auxiliary winding feedback type, a voltage substantially proportionate to the output voltage Vo is generated by rectifying and smoothing the voltage generated on the auxiliary winding. After that, the switching power supply of auxiliary winding feedback type performs constant voltage control on the output voltage Vo based on the voltage substantially proportionate to the output voltage Vo.

As an example of the switching power supply of the auxiliary winding feedback type of the prior art, a switching power supply which performs PWM control in current mode will be described in accordance with the accompanying drawings. FIG. 13 is a block diagram showing the switching power supply of the auxiliary winding feedback type according to the prior art which performs PWM control in current mode.

In FIG. 13, a power conversion transformer 110 has a primary winding T1, a secondary winding T2, and an auxiliary winding T3. The secondary winding T2 and the primary winding T1 are opposite in polarity. Thus the switching power supply is a flyback power supply.

The primary winding T1 of the power conversion transformer 110 has one terminal connected to the positive terminal of the input side of the switching power supply. The other terminal is connected to the negative terminal of the input side of the switching power supply via a switching element 1 which is a semiconductor element having a high withstand voltage.

The switching element 1 has an input terminal, an output terminal, and a control terminal. The input terminal is connected to the primary winding T1, and the output terminal is connected to the negative terminal of the input side of the switching power supply. Further, the switching element 1 oscillates so as to electrically connect and disconnect the input terminal and the output terminal in response to a control signal applied to the control terminal. The oscillating operation of the switching element 1 is called a switching operation. Hereinafter, this operation will be referred to as an oscillating operation or a switching operation. The switching element 1 is generally a power MOSFET.

By the switching operation of the switching element 1, a DC voltage VIN supplied from the input-side terminal of the switching power supply to the primary winding T1 is converted to a high-frequency pulse voltage and the pulse voltage is transferred to the secondary winding T2 and the auxiliary winding T3. The auxiliary winding T3 has the same polarity as the secondary winding T2. Thus a pulse voltage generated on the auxiliary winding T3 is proportionate to a pulse voltage generated on the secondary winding T2.

The secondary winding T2 of the power conversion transformer 110 is connected to an output voltage generating circuit 120. The output voltage generating circuit 120 includes a rectifier diode 121 and a smoothing capacitor 122. The rectifier diode 121 and the smoothing capacitor 122 rectify and smooth the pulse voltage generated on the secondary winding T2, so that an output voltage Vo on the secondary side is generated. The output voltage Vo is supplied to a load 140 connected to the output-side terminal of the switching power supply.

The auxiliary winding T3 of the power conversion transformer 110 is connected to a feedback signal generating circuit 130. The feedback signal generating circuit 130 includes a rectifier diode 131 and a smoothing capacitor 132. The rectifier diode 131 and the smoothing capacitor 132 rectify and smooth the pulse voltage generated on the auxiliary winding T3, so that an auxiliary power supply voltage VCC proportionate to the output voltage Vo is generated.

The switching operation of the switching element 1 is controlled by a control circuit 2. The control circuit 2 is formed on the same semiconductor substrate. The control circuit 2 has three terminals of a DRAIN terminal, a VCC terminal, and a SOURCE terminal as external connection terminals. The DRAIN terminal is connected to the primary winding T1 of the power conversion transformer 110, and the input terminal of the switching element 1 is connected to the primary winding T1 via the DRAIN terminal. The VCC terminal is connected to the feedback signal generating circuit 130. The VCC terminal is fed with the auxiliary power supply voltage VCC. The SOURCE terminal is connected to the negative terminal of the input side of the switching power supply, and the output terminal of the switching element 1 is connected to the negative terminal of the input side of the switching power supply via the SOURCE terminal.

The control circuit 2 generates the control signal applied to the control terminal of the switching element 1, based on the voltage of the VCC terminal, that is, the auxiliary power supply voltage VCC. The switching operation of the switching element 1 is controlled by the control signal.

The following will describe the internal configuration of the control circuit 2.

In the control circuit 2, a regulator 3 is connected to the VCC terminal and the DRAIN terminal. The regulator 3 supplies a current from one of the DRAIN terminal and the VCC terminal to an internal circuit power supply VDD of the control circuit 2. The current supply of the regulator 3 stabilizes the voltage of the internal circuit power supply VDD to a constant value.

To be specific, the regulator 3 supplies a current from the DRAIN terminal to the internal circuit power supply VDD and also supplies a current to the smoothing capacitor 132 through the VCC terminal before the start of the switching operation of the switching element 1. Thus before the start of the switching operation, the auxiliary power supply voltage VCC and the voltage of the internal circuit power supply VDD increase.

The regulator 3 stops the current supply from the DRAIN terminal to the VCC terminal after the start of the switching operation of the switching element 1. In other words, when the auxiliary power supply voltage VCC reaches at least a constant value, the regulator 3 supplies a current from the VCC terminal to the internal circuit power supply VDD based on the auxiliary power supply voltage VCC. The circuit current of the control circuit 2 is supplied thus from the auxiliary winding T3, so that power consumption is effectively reduced.

The VCC terminal is connected to the regulator 3 and acts as a current source of the control circuit 2. The VCC terminal is also connected to an error signal generating circuit 4 and also acts as a control terminal for feedback control.

The error signal generating circuit 4 is made up of an OP amplifier 5, resistors 6a and 6b, and a resistor 7. The resistors 6a and 6b divide the voltage of the VCC terminal, that is, the auxiliary power supply voltage VCC. The divided voltage is applied to the inverting input terminal of the OP amplifier 5. The resistor 7 is connected between the inverting input terminal and the output terminal of the OP amplifier 5. The resistance value of the resistor 7 determines the amplification factor of the OP amplifier 5. Further, the non-inverting input terminal of the OP amplifier 5 is fed with a reference voltage Vref. In the switching power supply of the prior art, the reference voltage Vref is kept constant.

In the error signal generating circuit 4 configured thus, an error amplification signal VEAO is generated by amplifying a difference between the voltage obtained by dividing the voltage of the VCC terminal and the reference voltage Vref. The error amplification signal VEAO is supplied to a drain current control circuit 12 and an intermittent oscillation control circuit 15.

A drain current detection circuit 11 is disposed between the DRAIN terminal and the input terminal of the switching element 1. The drain current detection circuit 11 detects the current value of a current ID passing through the switching element 1 and generates a drain current detection signal VCL having a voltage value corresponding to the detected current value. The drain current detection signal VCL is supplied to the drain current control circuit 12. Hereinafter, a current passing through the switching element 1 will be referred to as a drain current.

The drain current control circuit 12 is fed with an overcurrent protection reference voltage VLIMIT and the error amplification signal VEAO from the error signal generating circuit 4 as reference voltages. When the voltage value of the drain current detection signal VCL reaches lower one of the overcurrent protection reference voltage VLIMIT and the voltage value of the error amplification signal VEAO, the drain current control circuit 12 generates a signal for turning off the switching element 1. The signal for turning off the switching element 1 is supplied to the reset terminal of a latch circuit 13. In other words, the latch circuit 13 is reset by the signal from the drain current control circuit 12.

An oscillator 8 oscillates with a constant period a clock signal for turning on the switching element 1. The clock signal is supplied to the set terminal of the latch circuit 13. In other words, the latch circuit 13 is set by the clock signal from the oscillator 8.

From the set state to the reset state of the latch circuit 13, the latch circuit 13 generates a signal for turning on the switching element 1. In other words, the switching element 1 is controlled to be turned on by the clock signal from the oscillator 8 and is controlled to be turned off by the signal from the drain current control circuit 12.

A gate driver 14 generates the control signal for driving the switching element 1, based on the signal generated in the latch circuit 13.

The control circuit 2 controls the switching operation of the switching element 1 thus based on the auxiliary power supply voltage VCC proportionate to the output voltage Vo. In other words, the auxiliary power supply voltage VCC is used as a feedback signal in the control circuit 2.

According to the foregoing configuration, in the switching power supply for performing PWM control in current mode, the peak value of the drain current ID passing through the switching element 1 is controlled according to the signal level of the error amplification signal VEAO. Further, the output voltage Vo is stabilized by controlling the peak value.

The control circuit 2 of the switching power supply further includes the intermittent oscillation control circuit 15 for reducing standby power consumption. The intermittent oscillation control circuit 15 controls the stop and restart of the switching operation of the switching element 1 according to the signal level of the error amplification signal VEAO from the error signal generating circuit 4.

To be specific, when the signal level of the error amplification signal VEAO decreases to a light load detection level VEAO1 at a light load, the intermittent oscillation control circuit 15 stops the switching operation of the switching element 1 by changing the signal level of an Enable signal supplied to the gate driver 14. After the switching operation of the switching element 1 is stopped, the output voltage Vo decreases and the signal level of the error amplification signal VEAO increases. However, the light load detection level has hysteresis of ΔVEAO and thus the intermittent oscillation control circuit 15 stops the switching operation of the switching element 1 until the signal level of the error amplification signal VEAO reaches “VEAO1+VEAO”. When the signal level of the error amplification signal VEAO reaches “VEAO1+ΔVEAO”, the intermittent oscillation control circuit 15 restarts the switching operation of the switching element 1 by changing the signal level of the Enable signal. As a result, the operation of the switching element 1 at a light load is an intermittent oscillating operation which reduces a switching loss.

In this way, the intermittent oscillation of the switching element 1 at a light load reduces standby power consumption. Further, as the load decreases, the output voltage Vo decreases with a smaller inclination during a stopped switching operation and the switching operation is stopped for an extended period, so that standby power consumption is reduced. Such a technique for reducing standby power consumption is disclosed in, for example, Japanese Patent Laid-Open No. 2001-224169.

In the switching power supply of the prior art, however, as shown in FIG. 14, the output voltage Vo disadvantageously decreases with an increase in the load and an output current Io even when the voltage of the VCC terminal is substantially kept constant relative to the output voltage Io. The output voltage Vo is reduced by an output-side wiring resistance and the leakage inductance of the transformer.

To address the problem, a technique for improving the dependence of an output voltage on a load has been proposed. In this technique, to be specific, the reference level of a feedback signal is reduced at a light load and is increased at a heavy load according to the signal level of drain current passing through the switching element under PWM control, so that the inclination of the output voltage is corrected. This technique is disclosed in, for example, Japanese Patent Laid-Open No. 7-170731.

However, in the switching power supply of the prior art, the reference level of the feedback signal is controlled according to the drain current of the switching element under PWM control, so that the output voltage increases as the load comes close to an unloaded condition and the output voltage rapidly increases at no load.

This problem is caused by the characteristics of PWM control. To be specific, in PWM control, one of the peak value of drain current passing through the switching element and the pulse width of the control signal applied to the control terminal of the switching element is controlled according to a load. The lighter the load, the lower the peak current and the smaller the pulse width. However, when the pulse width of the control signal decreases, the delay time of the control circuit cannot be negligible. Thus the lighter the load, the lower the accuracy of feedback control and the higher the output voltage. Moreover, in order to prevent erroneous detection of a spike voltage immediately after the switching element is turned on, the control circuit has a delay time called a blanking time which determines the minimum pulse width of the control signal. In other words, the pulse width of the control signal cannot be smaller than the minimum pulse width even at no load. Thus feedback control is limited at a light load. When feedback control reaches the limit, the output voltage considerably increases.

In the switching power supply for controlling the reference level of the feedback signal by using the drain current according to the prior art, the drain current is considerably affected by the delay time and the blanking time of the control circuit. Thus it is not possible to solve the problem of an increase in output voltage at a light load.

In order to prevent the output voltage from increasing at a light load, a dummy resistor may be connected to a secondary-side output. Since the dummy resistor consumes a constant dummy current even at a light load, it is possible to suppress an increase in output voltage but power consumption increases.

### DISCLOSURE OF THE INVENTION

The present invention has been devised in view of the foregoing problems. An object of the present invention is to provide a switching power supply of auxiliary winding feedback type which can suppress an increase in output voltage at a light load without using a dummy resistor, and a semiconductor device for the switching power supply.

In order to attain the object, a first switching power supply of the present invention includes:

a transformer having a primary winding, a secondary winding, and an auxiliary winding, the primary winding being fed with a first DC voltage;

a switching element connected to the primary winding to generate voltages on the secondary winding and the auxiliary winding by a switching operation;

an output voltage generating circuit for generating a second DC voltage from the voltage generated on the secondary winding;

a feedback signal generating circuit for generating a feedback signal from the voltage generated on the auxiliary winding;

an oscillator circuit for oscillating a signal for turning on the switching element;

an error signal generating circuit for detecting the signal level of the feedback signal and generating an error signal having a signal level corresponding to a difference between the detected signal level and a reference level;

a switching control circuit for turning on the switching element at a time in response to the signal oscillated by the oscillator circuit and turning off the switching element at a time in response to the signal level of the error signal; and

a reference level control circuit for controlling the reference level according to one of a time period during which the switching operation of the switching element is stopped and the switching frequency of the switching element.

Further, the reference level control circuit may internally generate a signal changing between at least two levels.

The reference level control circuit preferably includes a low-pass filter for cutting off a frequency lower than the operating frequency of the feedback signal.

Further, the switching control circuit may include an intermittent oscillation control circuit for controlling the stop and restart of the switching operation of the switching element according to the signal level of the error signal, and the reference level control circuit may control the reference level based on a signal from the intermittent oscillation control circuit according to the time period during which the switching operation of the switching element is stopped. Alternatively, the switching control circuit may include a frequency control circuit for controlling the switching frequency of the switching element according to the signal level of the error signal, and the reference level control circuit may control the reference level based on a signal from the frequency control circuit according to the switching frequency of the switching element.

Moreover, the feedback signal generating circuit may include a rectifier diode and a smoothing capacitor, and the feedback signal may be generated by the rectifier diode and the smoothing capacitor which rectify and smooth the voltage generated on the auxiliary winding. In this case, the first switching power supply of the present invention may include a semiconductor device having at least three external connection terminals and a semiconductor substrate, wherein the switching element, the oscillator circuit, the error signal generating circuit, the switching control circuit, and the reference level control circuit are formed on the semiconductor substrate, or the oscillator circuit, the error signal generating circuit, the switching control circuit, and the reference level control circuit are formed on the semiconductor substrate.

Alternatively, the feedback signal generating circuit may include a resistor for detecting the voltage generated on the auxiliary winding, and a sampling circuit for sampling the voltage value of the voltage as the feedback signal before the voltage detected by the resistor rapidly decreases. In this case, the first switching power supply of the present invention may include a semiconductor device having at least four external connection terminals and a semiconductor substrate, wherein the switching element, the oscillator circuit, the error signal generating circuit, the switching control circuit, the reference level control circuit, and the sampling circuit of the feedback signal generating circuit are formed on the semiconductor substrate, or the oscillator circuit, the error signal generating circuit, the switching control circuit, the reference level control circuit, and the sampling circuit of the feedback signal generating circuit are formed on the semiconductor substrate.

In order to attain the object, a second switching power supply of the present invention includes:

a transformer having a primary winding, a secondary winding, and an auxiliary winding, the primary winding being fed with a first DC voltage;

a switching element connected to the primary winding to generate voltages on the secondary winding and the auxiliary winding by a switching operation;

an output voltage generating circuit for generating a second DC voltage from the voltage generated on the secondary winding;

a feedback signal generating circuit for generating a feedback signal from the voltage generated on the auxiliary winding;

an oscillator circuit for oscillating a signal for turning on the switching element;

an error signal generating circuit for detecting the signal level of the feedback signal and generating an error signal having a signal level corresponding to a difference between the detected signal level and a reference level;

a switching control circuit for turning on the switching element at a time in response to the signal oscillated by the oscillator circuit and turning off the switching element at a time in response to the signal level of the error signal; and

a correction circuit for correcting the detected level of the feedback signal in the error signal generating circuit according to one of a time period during which the switching operation of the switching element is stopped and the switching frequency of the switching element.

Further, the correction circuit preferably includes a low-pass filter for cutting off a frequency lower than the operating frequency of the feedback signal.

Moreover, the switching control circuit may include an intermittent oscillation control circuit for controlling the stop and restart of the switching operation of the switching element according to the signal level of the error signal, and the correction circuit may correct the detected level of the feedback signal in the error signal generating circuit based on a signal from the intermittent oscillation control circuit according to the time period during which the switching operation of the switching element is stopped. Alternatively, the switching control circuit may include a frequency control circuit for controlling the switching frequency of the switching element according to the signal level of the error signal, and the correction circuit may correct the detected level of the feedback signal in the error signal generating circuit based on a signal from the frequency control circuit according to the switching frequency of the switching element.

Further, the feedback signal generating circuit may include a rectifier diode and a smoothing capacitor and the feedback signal is generated by the rectifier diode and the smoothing capacitor which rectify and smooth the voltage generated on the auxiliary winding. In this case, the second switching power supply of the present invention may include a semiconductor device having at least three external connection terminals and a semiconductor substrate, wherein the switching element, the oscillator circuit, the error signal generating circuit, the switching control circuit, and the correction circuit are formed on the semiconductor substrate, or the oscillator circuit, the error signal generating circuit, the switching control circuit, and the correction circuit are formed on the semiconductor substrate.

Alternatively, the feedback signal generating circuit may include a resistor for detecting the voltage generated on the auxiliary winding, and a sampling circuit for sampling the voltage value of the voltage as the feedback signal before the voltage detected by the resistor rapidly decreases. In this case, the second switching power supply of the present invention may include a semiconductor device having at least four external connection terminals and a semiconductor substrate, wherein the switching element, the oscillator circuit, the error signal generating circuit, the switching control circuit, the correction circuit, and the sampling circuit of the feedback signal generating circuit are formed on the semiconductor substrate, or the oscillator circuit, the error signal generating circuit, the switching control circuit, the correction circuit, and the sampling circuit of the feedback signal generating circuit are formed on the semiconductor substrate.

In order to attain the object, a first semiconductor device for the switching power supply of the present invention includes:

a switching element which is connected to the primary winding of a transformer fed with a DC voltage and generates voltages on the secondary winding and the auxiliary winding of the transformer by a switching operation; and

a control circuit for controlling the switching operation of the switching element based on a feedback signal generated from the voltage generated on the auxiliary winding.

Further, the control circuit includes:

an oscillator circuit for oscillating a signal for turning on the switching element;

an error signal generating circuit for detecting the signal level of the feedback signal and generating an error signal having a signal level corresponding to a difference between the detected signal level and a reference level;

a switching control circuit for turning on the switching element at a time in response to the signal oscillated by the oscillator circuit and turning off the switching element at a time in response to the signal level of the error signal; and

a reference level control circuit for controlling the reference level according to one of a time period during which the switching operation of the switching element is stopped and the switching frequency of the switching element.

Moreover, the reference level control circuit may internally generate a signal changing between at least two levels.

Further, the reference level control circuit preferably includes a low-pass filter for cutting off a frequency lower than the operating frequency of the feedback signal.

Moreover, the switching control circuit may include an intermittent oscillation control circuit for controlling the stop and restart of the switching operation of the switching element according to the signal level of the error signal, and the reference level control circuit may control the reference level based on a signal from the intermittent oscillation control circuit according to the time period during which the switching operation of the switching element is stopped. Alternatively, the switching control circuit may include a frequency control circuit for controlling the switching frequency of the switching element according to the signal level of the error signal, and the reference level control circuit may control the reference level based on a signal from the frequency control circuit according to the switching frequency of the switching element.

Further, the control circuit may include a sampling circuit for sampling the voltage value of the voltage generated on the auxiliary winding and detected by an external resistor, as the feedback signal before the voltage rapidly decreases.

In order to attain the object, a second semiconductor device for the switching power supply of the present invention includes:

a switching element which is connected to the primary winding of a transformer fed with a DC voltage and generates voltages on the secondary winding and the auxiliary winding of the transformer by a switching operation; and

a control circuit for controlling the switching operation of the switching element based on a feedback signal generated from the voltage generated on the auxiliary winding.

Further, the control circuit includes:

an oscillator circuit for oscillating a signal for turning on the switching element;

an error signal generating circuit for detecting the signal level of the feedback signal and generating an error signal having a signal level corresponding to a difference between the detected signal level and a reference level;

a switching control circuit for turning on the switching element at a time in response to the signal oscillated by the oscillator circuit and turning off the switching element at a time in response to the signal level of the error signal; and

a correction circuit for correcting the detected level of the feedback signal in the error signal generating circuit according to one of a time period during which the switching operation of the switching element is stopped and the switching frequency of the switching element.

Moreover, the correction circuit preferably includes a low-pass filter for cutting off a frequency lower than the operating frequency of the feedback signal.

Further, the switching control circuit may include an intermittent oscillation control circuit for controlling the stop and restart of the switching operation of the switching element according to the signal level of the error signal, and the correction circuit may correct the detected level of the feedback signal in the error signal generating circuit based on a signal from the intermittent oscillation control circuit according to the time period during which the switching operation of the switching element is stopped. Alternatively, the switching control circuit may include a frequency control circuit for controlling the switching frequency of the switching element according to the signal level of the error signal, and the correction circuit may correct the detected level of the feedback signal in the error signal generating circuit based on a signal from the frequency control circuit according to the switching frequency of the switching element.

Moreover, the control circuit may further include a sampling circuit for sampling the voltage value of the voltage generated on the auxiliary winding and detected by an external resistor, as the feedback signal before the voltage rapidly decreases.

In order to attain the object, a third semiconductor device for the switching power supply includes a control circuit which is connected to the primary winding of a transformer fed with a DC voltage and controls the switching operation of a switching element for generating voltages on the secondary winding and the auxiliary winding of the transformer by the switching operation, the switching operation being controlled based on a feedback signal generated from the voltage generated on the auxiliary winding of the transformer.

Further, the control circuit includes:

an oscillator circuit for oscillating a signal for turning on the switching element;

an error signal generating circuit for detecting the signal level of the feedback signal and generating an error signal having a signal level corresponding to a difference between the detected signal level and a reference level;

a switching control circuit for turning on the switching element at a time in response to the signal oscillated by the oscillator circuit and turning off the switching element at a time in response to the signal level of the error signal; and

a reference level control circuit for controlling the reference level according to one of a time period during which the switching operation of the switching element is stopped and the switching frequency of the switching element.

Further, the reference level control circuit may internally generate a signal changing between at least two levels.

Moreover, the reference level control circuit preferably includes a low-pass filter for cutting off a frequency lower than the operating frequency of the feedback signal.

Further, the switching control circuit may include an intermittent oscillation control circuit for controlling the stop and restart of the switching operation of the switching element according to the signal level of the error signal, and the reference level control circuit may control the reference level based on a signal from the intermittent oscillation control circuit according to the time period during which the switching operation of the switching element is stopped. Alternatively, the switching control circuit may include a frequency control circuit for controlling the switching frequency of the switching element according to the signal level of the error signal, and the reference level control circuit may control the reference level based on a signal from the frequency control circuit according to the switching frequency of the switching element.

Moreover, the control circuit may further include a sampling circuit for sampling the voltage value of the voltage generated on the auxiliary winding and detected by an external resistor, as the feedback signal before the voltage rapidly decreases.

In order to attain the object, a fourth semiconductor device for the switching power supply of the present invention includes a control circuit which is connected to the primary winding of a transformer fed with a DC voltage and controls the switching operation of a switching element for generating voltages on the secondary winding and the auxiliary winding of the transformer by the switching operation, the switching operation being controlled based on a feedback signal generated from the voltage generated on the auxiliary winding of the transformer.

Moreover, the control circuit includes:

an oscillator circuit for oscillating a signal for turning on the switching element;

an error signal generating circuit for detecting the signal level of the feedback signal and generating an error signal having a signal level corresponding to a difference between the detected signal level and a reference level;

a switching control circuit for turning on the switching element at a time in response to the signal oscillated by the oscillator circuit and turning off the switching element at a time in response to the signal level of the error signal; and

a correction circuit for correcting the detected level of the feedback signal in the error signal generating circuit according to one of a time period during which the switching operation of the switching element is stopped and the switching frequency of the switching element.

Further, the correction circuit preferably includes a low-pass filter for cutting off a frequency lower than the operating frequency of the feedback signal.

Moreover, the switching control circuit may include an intermittent oscillation control circuit for controlling the stop and restart of the switching operation of the switching element according to the signal level of the error signal, and the correction circuit may correct the detected level of the feedback signal in the error signal generating circuit based on a signal from the intermittent oscillation control circuit according to the time period during which the switching operation of the switching element is stopped. Alternatively, the switching control circuit may include a frequency control circuit for controlling the switching frequency of the switching element according to the signal level of the error signal, and the correction circuit may correct the detected level of the feedback signal in the error signal generating circuit based on a signal from the frequency control circuit according to the switching frequency of the switching element.

Further, the control circuit may further include a sampling circuit for sampling the voltage value of the voltage generated on the auxiliary winding and detected by an external resistor, as the feedback signal before the voltage rapidly decreases.

According to preferred embodiments of the present invention, it is possible to suppress an increase in output voltage at a light load without using expensive components such as a photocoupler and a secondary-side output voltage detection circuit or using a dummy resistor. Thus it is possible to improve the constant voltage characteristics of the output voltage at a light load.

For this reason, the present invention is useful for switching power supplies used for the chargers of portable equipment and the power supply circuits of other kinds of electrical equipment. The present invention is further applicable to electrical equipment requiring small and inexpensive power supply circuits.

### BRIEF DESCRIPTION OF THE DRAWINGS

FIG. 1 is a block diagram showing a structural example of a switching power supply according to a first embodiment of the present invention;

FIG. 2 is a circuit diagram showing a structural example of a reference level control circuit included in the switching power supply according to the first embodiment of the present invention;

FIG. 3 shows the relationship between the switching operation of a switching element and a voltage VR1 and a reference voltage Vref at a light load in the switching power supply according to the first embodiment of the present invention;

FIG. 4 shows the relationship between an output current Io and an output voltage Vo and the relationship between the output current Io and the reference voltage Vref in the switching power supply according to the first embodiment of the present invention;

FIG. 5 is a circuit diagram showing another structural example of the reference level control circuit included in the switching power supply according to the first embodiment of the present invention;

FIG. 6 is a block diagram showing another structural example of the switching power supply according to the first embodiment of the present invention;

FIG. 7 is a block diagram showing a structural example of a switching power supply according to a second embodiment of the present invention;

FIG. 8 is a circuit diagram showing a structural example of a reference level control circuit included in the switching power supply according to the second embodiment of the present invention;

FIG. 9 is a block diagram showing a structural example of a switching power supply according to a third embodiment of the present invention;

FIG. 10 is a circuit diagram showing a structural example of a detected signal correction circuit included in the switching power supply according to the third embodiment of the present invention;

FIG. 11 is a block diagram showing a structural example of a switching power supply according to a fourth embodiment of the present invention;

FIG. 12 is a circuit diagram showing a structural example of a detected signal correction circuit included in the switching power supply according to the fourth embodiment of the present invention;

FIG. 13 is a block diagram showing a switching power supply of the prior art; and

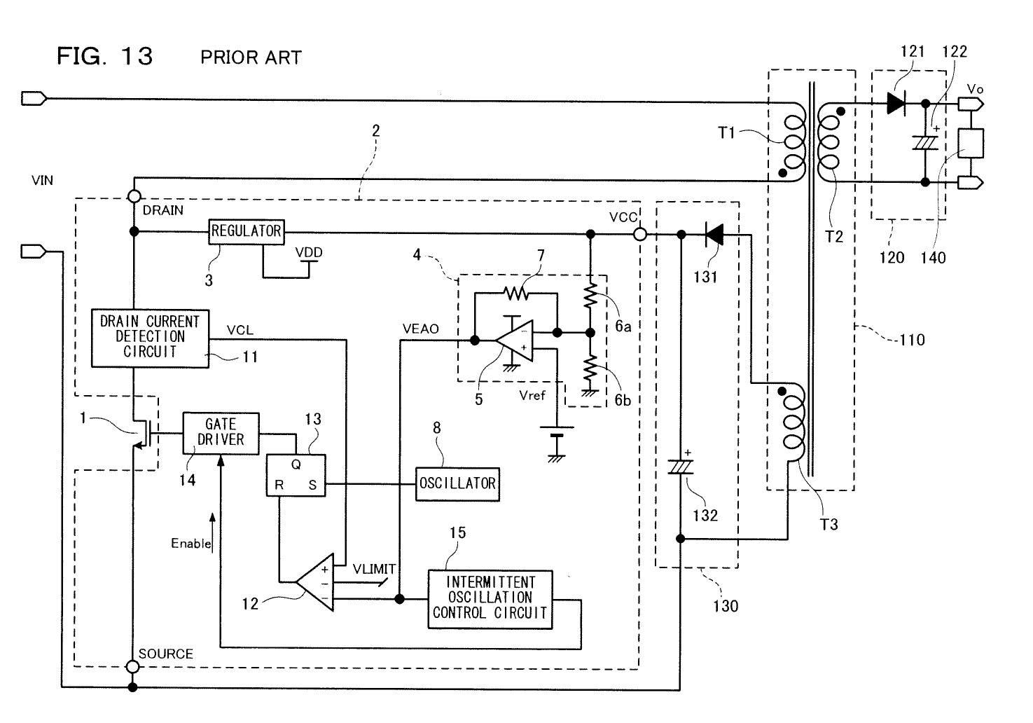

FIG. 14 shows the relationship between an output current Io and an output voltage Vo and the relationship between the output current Io and a VCC terminal voltage in the switching power supply of the prior art.

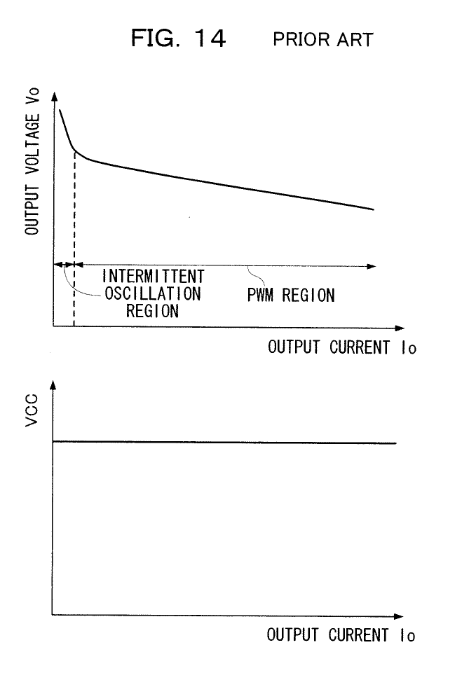

### DESCRIPTION OF THE EMBODIMENTS

The following will describe embodiments of a switching power supply and a semiconductor device for the switching power supply according to the present invention with reference to the accompanying drawings. The same elements as the foregoing explanation are indicated by the same reference numerals and the explanation thereof is omitted as necessary.

### First Embodiment

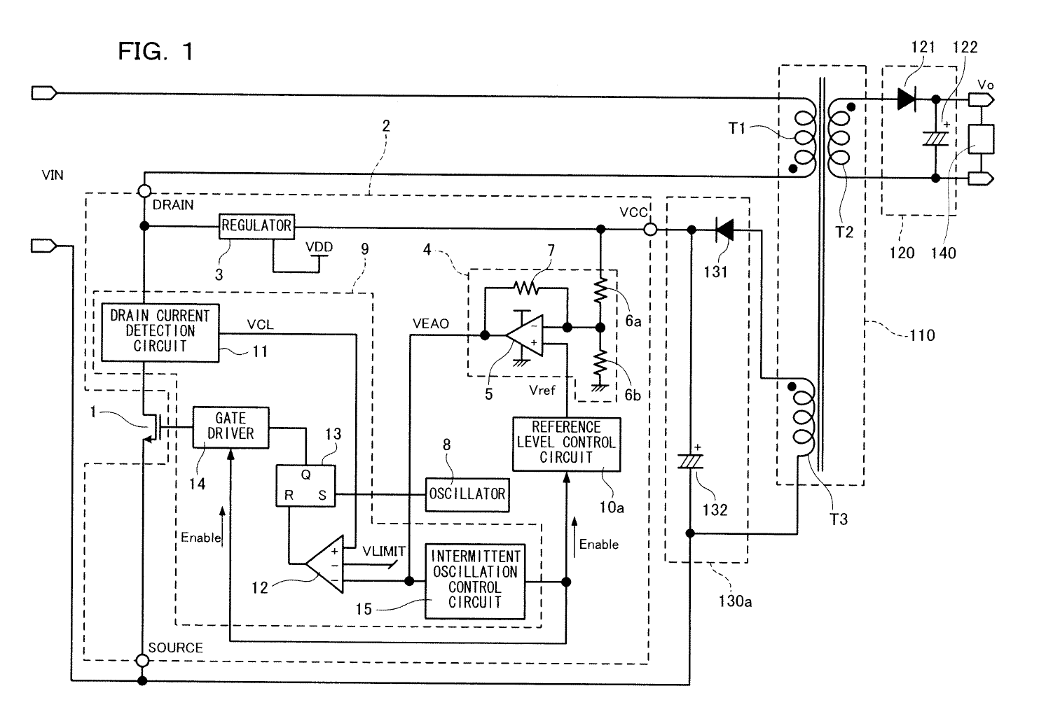

A switching power supply and a semiconductor device for the switching power supply will be described below according to a first embodiment of the present invention. FIG. 1 is a block diagram showing a structural example of the switching power supply according to the first embodiment of the present invention.

In FIG. 1, a power conversion transformer 110 has a primary winding T1, a secondary winding T2, and an auxiliary winding T3. The secondary winding T2 and the primary winding T1 are opposite in polarity. Thus the switching power supply is a flyback power supply.

The primary winding T1 of the power conversion transformer 110 has one terminal connected to the positive terminal of the input side of the switching power supply. The other terminal is connected to the negative terminal of the input side of the switching power supply via a switching element 1 which is a semiconductor element having a high withstand voltage.

The switching element 1 has an input terminal, an output terminal, and a control terminal. The input terminal is connected to the primary winding T1, and the output terminal is connected to the negative terminal of the input side of the switching power supply. Further, the switching element 1 oscillates so as to electrically connect and disconnect the input terminal and the output terminal in response to a control signal applied to the control terminal. The switching element 1 may be, for example, a power MOSFET.

By the switching operation of the switching element 1, a first DC voltage VIN supplied from the input-side terminal of the switching power supply to the primary winding T1 is converted to a high-frequency pulse voltage and the pulse voltage is transferred to the secondary winding T2 and the auxiliary winding T3. The auxiliary winding T3 has the same polarity as the secondary winding T2. Thus a pulse voltage generated on the auxiliary winding T3 is proportionate to a pulse voltage generated on the secondary winding T2.

By the switching operation of the switching element 1 connected to the primary winding T1 fed with the first DC voltage VIN, voltages are generated on the secondary winding T2 and the auxiliary winding T3 of the power conversion transformer 110.

The secondary winding T2 of the power conversion transformer 110 is connected to an output voltage generating circuit 120. The output voltage generating circuit 120 generates a second DC voltage from the voltage generated on the secondary winding T2.

To be specific, the output voltage generating circuit 120 includes a rectifier diode 121 and a smoothing capacitor 122. The rectifier diode 121 and the smoothing capacitor 122 rectify and smooth the pulse voltage generated on the secondary winding T2, so that the second DC voltage is generated. The second DC voltage is supplied to a load 140 connected to the output-side terminal of the switching power supply. In other words, the second DC voltage is an output voltage Vo of the secondary side.

The auxiliary winding T3 of the power conversion transformer 110 is connected to a feedback signal generating circuit 130a. The feedback signal generating circuit 130a generates an auxiliary power supply voltage VCC from the voltage generated on the auxiliary winding T3. To be specific, the feedback signal generating circuit 130a includes a rectifier diode 131 and a smoothing capacitor 132. The rectifier diode 131 and the smoothing capacitor 132 rectify and smooth the pulse voltage generated on the auxiliary winding T3. Thus the auxiliary power supply voltage VCC proportionate to the output voltage Vo is generated.

The switching operation of the switching element 1 is controlled by a control circuit 2 included in the semiconductor device for the switching power supply. The control circuit 2 is formed on the same semiconductor substrate. The semiconductor device for the switching power supply has three terminals of a DRAIN terminal, a VCC terminal, and a SOURCE terminal as external connection terminals. The DRAIN terminal is connected to the primary winding T1 of the power conversion transformer 110, and the input terminal of the switching element 1 is connected to the primary winding T1 via the DRAIN terminal. The VCC terminal is connected to the feedback signal generating circuit 130a. The VCC terminal is fed with the auxiliary power supply voltage VCC. The SOURCE terminal is connected to the negative terminal of the input side of the switching power supply, and the output terminal of the switching element 1 is connected to the negative terminal of the input side of the switching power supply via the SOURCE terminal.

The control circuit 2 generates the control signal applied to the control terminal of the switching element 1, based on the voltage of the VCC terminal, that is, the auxiliary power supply voltage VCC. The switching operation of the switching element 1 is controlled by the control signal.

The following will describe the internal configuration of the control circuit 2.

In the control circuit 2, a regulator 3 is connected to the VCC terminal and the DRAIN terminal. The regulator 3 supplies a current from one of the DRAIN terminal and the VCC terminal to an internal circuit power supply VDD of the control circuit 2. The current supply of the regulator 3 stabilizes the voltage of the internal circuit power supply VDD to a constant value.

To be specific, the regulator 3 supplies a current from the DRAIN terminal to the internal circuit power supply VDD and also supplies a current to the smoothing capacitor 132 through the VCC terminal before the start of the switching operation of the switching element 1. Thus the auxiliary power supply voltage VCC and the voltage of the internal circuit power supply VDD increase before the start of the switching operation.

After the switching operation of the switching element 1 is started, the regulator 3 stops the current supply from the DRAIN terminal to the VCC terminal. In other words, when the auxiliary power supply voltage VCC reaches at least a constant value, the regulator 3 supplies a current from the VCC terminal to the internal circuit power supply VDD based on the auxiliary power supply voltage VCC. The circuit current of the control circuit 2 is supplied thus from the auxiliary winding T3, so that power consumption is effectively reduced.

The VCC terminal is connected to the regulator 3 to act as a current source of the control circuit 2 and is simultaneously connected to an error signal generating circuit 4 to also act as a control terminal for feedback control.

The error signal generating circuit 4 detects a voltage value as the signal level of the auxiliary power supply voltage VCC and determines a difference between the detected voltage value and a reference voltage serving as a reference level, so that an error amplification signal VEAO is generated as an error signal. The signal level of the error amplification signal VEAO has a voltage value corresponding to the difference between the detected voltage value of the auxiliary power supply voltage VCC and the reference voltage.

To be specific, the error signal generating circuit 4 is made up of an OP amplifier 5, resistors 6a and 6b, and a resistor 7. The resistors 6a and 6b divide the voltage of the VCC terminal, that is, the auxiliary power supply voltage VCC. The divided voltage is applied to the inverting input terminal of the OP amplifier 5. The resistor 7 is connected between the inverting input terminal and the output terminal of the OP amplifier 5. The resistance value of the resistor 7 determines the amplification factor of the OP amplifier 5. Further, the non-inverting input terminal of the OP amplifier 5 is fed with a reference voltage Vref generated by a reference level control circuit 10a. The reference voltage Vref is used as the reference level of the auxiliary power supply voltage VCC serving as a feedback signal.

In the error signal generating circuit 4 configured thus, the error amplification signal VEAO is generated by amplifying a difference between the voltage obtained by dividing the voltage of the VCC terminal and the reference voltage Vref. The error amplification signal VEAO is supplied to a drain current control circuit 12 and an intermittent oscillation control circuit 15 which are included in a switching control circuit 9.

An oscillator 8 acting as an oscillator circuit oscillates with a constant period a clock signal for turning on the switching element 1. The clock signal is supplied to the set terminal of a latch circuit 13 included in the switching control circuit 9. In other words, the latch circuit 13 is set by the clock signal from the oscillator 8.

The switching control circuit 9 turns on the switching element 1 at a time in response to the clock signal oscillated by the oscillator 8, and turns off the switching element 1 at a time in response to the signal level of the error amplification signal VEAO from the error signal generating circuit 4.

To be specific, the switching control circuit 9 is made up of a drain current detection circuit 11, the drain current control circuit 12, the latch circuit 13, a gate driver 14, and the intermittent oscillation control circuit 15.

The drain current detection circuit 11 is disposed between the DRAIN terminal and the input terminal of the switching element 1. The drain current detection circuit 11 detects the current value of a drain current ID passing through the switching element 1 and generates a drain current detection signal VCL having a voltage value corresponding to the detected current value. The drain current detection signal VCL is supplied to the drain current control circuit 12.

The drain current control circuit 12 is fed with an overcurrent protection reference voltage VLIMIT and the error amplification signal VEAO from the error signal generating circuit 4 as reference voltages. When the voltage value of the drain current detection signal VCL reaches lower one of the overcurrent protection reference voltage VLIMIT and the voltage value of the error amplification signal VEAO, the drain current control circuit 12 generates a signal for turning off the switching element 1. The signal for turning off the switching element 1 is supplied to the reset terminal of the latch circuit 13. In other words, the latch circuit 13 is reset by the signal from the drain current control circuit 12.

From the set state to the reset state of the latch circuit 13, the latch circuit 13 generates a signal for turning on the switching element 1. In other words, the switching element 1 is controlled to be turned on by the clock signal from the oscillator 8 and is controlled to be turned off by the signal from the drain current control circuit 12.

The gate driver 14 generates the control signal for driving the switching element 1, based on the signal generated in the latch circuit 13.

The control circuit 2 controls the switching operation of the switching element 1 thus based on the auxiliary power supply voltage VCC proportionate to the output voltage Vo. In other words, the auxiliary power supply voltage VCC is used as a feedback signal in the control circuit 2.

According to the foregoing configuration, in the switching power supply, the peak value of the drain current ID passing through the switching element 1 is controlled according to the signal level of the error amplification signal VEAO. Further, the output voltage Vo is stabilized by controlling the peak value. In other words, the switching power supply is a switching power supply of auxiliary winding feedback type for performing PWM control in current mode.

Moreover, the control circuit 2 of the switching power supply includes the intermittent oscillation control circuit 15 for reducing standby power consumption. The intermittent oscillation control circuit 15 controls the stop and restart of the switching operation of the switching element 1 according to the signal level of the error amplification signal VEAO from the error signal generating circuit 4.

In other words, when the signal level of the error amplification signal VEAO decreases to a light load detection level VEAO1 at a light load, the intermittent oscillation control circuit 15 stops the switching operation of the switching element 1 by changing the signal level of an Enable signal supplied to the gate driver 14. After the switching operation of the switching element 1 is stopped, the output voltage Vo decreases and the signal level of the error amplification signal VEAO increases. However, the light load detection level has hysteresis of ΔVEAO and thus the intermittent oscillation control circuit 15 stops the switching operation of the switching element 1 until the signal level of the error amplification signal VEAO reaches “VEAO1+ΔVEAO”. When the signal level of the error amplification signal VEAO reaches “VEAO1+ΔVEAO”, the intermittent oscillation control circuit 15 restarts the switching operation of the switching element 1 by changing the signal level of the Enable signal. As a result, the operation of the switching element 1 at a light load is an intermittent oscillating operation which reduces a switching loss.

In this way, the intermittent oscillation of the switching element 1 at a light load reduces standby power consumption. Further, as the load decreases, the output voltage Vo decreases with a smaller inclination during a stopped switching operation and the switching operation is stopped for an extended period, so that standby power consumption is reduced.

The control circuit 2 of the switching power supply further includes the reference level control circuit 10a for suppressing an increase in the output voltage Vo at a light load. The reference level control circuit 10a controls the reference voltage Vref according to a time period during which the switching operation of the switching element 1 is stopped, based on the Enable signal from the intermittent oscillation control circuit 15. To be specific, as the load decreases and the switching operation of the switching element 1 is stopped for a longer period, the reference voltage Vref decreases.

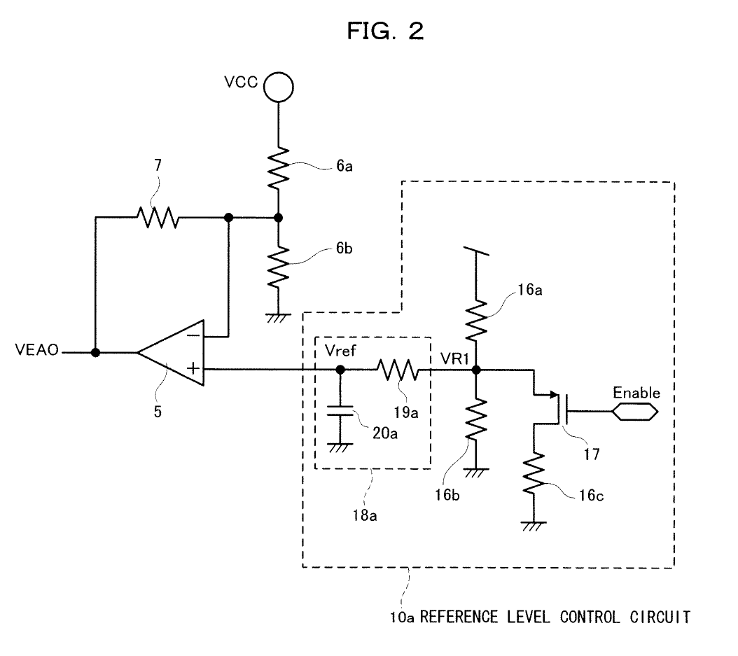

FIG. 2 shows a structural example of the reference level control circuit 10a. The reference level control circuit 10a is made up of resistors 16a, 16b and 16c, a switch element 17, and a low-pass filter 18a.

The resistor 16a and the resistor 16b are connected in series between the power supply line and the ground line of the control circuit 2, and the resistor 16c is connected in parallel with the resistor 16b via the switch element 17.

The switch element 17 is controlled to be turned on and off by the Enable signal from the intermittent oscillation control circuit 15. In the following explanation, the signal level of the Enable signal is set at Low level when the intermittent oscillation control circuit 15 stops the switching operation of the switching element 1, and the signal level of the Enable signal is set at High level when the intermittent oscillation control circuit 15 permits the switching operation of the switching element 1. In this case, the switch element 17 is, for example, a P-type MOSFET as shown in FIG. 2.

With this configuration, in a period during which the switching operation of the switching element 1 is performed, the signal level of the Enable signal is High level, the switch element 17 is turned off, and the resistor 16c is electrically disconnected from the resistor 16b. Thus a voltage VR1 obtained by dividing a power supply voltage VDD of the control circuit 2 by the resistor 16a and the resistor 16b is generated on the junction point of the resistor 16a and the resistor 16b. The voltage VR1 at this point is expressed by the following equation:

VR1=VDD·R2/(R1+R2)

where R1 is the resistance value of the resistor 16a and R2 is the resistance value of the resistor 16b. In a period during which the switching operation of the switching element 1 is stopped, the signal level of the Enable signal is Low level, the switch element 17 is turned on, and the resistor 16c is electrically connected in parallel with the resistor 16b. Thus a voltage VR1 obtained by dividing the power supply voltage VDD of the control circuit 2 by the resistors 16a, 16b and 16c is generated on the junction point of the resistor 16a and the resistor 16b. The voltage VR1 at this point is expressed by the following equation:

VR1=VDD·R23/(R1+R23)

where R23 is the combined resistance value of the resistor 16b and the resistor 16c. The combined resistance value R23 is expressed by the following equation:

R23=R2·R3/(R2+R3)

where R3 is the resistance value of the resistor 16c.

Since the resistance value R2 is larger than the combined resistance value R23, the voltage VR1 with the Enable signal at Low level is lower than the voltage VR1 with the Enable signal at High level. Thus at a light load, the signal level of the Enable signal changes between High level and Low level and the voltage VR1 also changes between the two levels, accordingly. In normal PWM control, the signal level of the Enable signal is kept at High level and thus the voltage VR1 is also kept at a constant value.

As has been discussed, the reference level control circuit 10a internally generates the voltage VR1 having a constant value in normal PWM control. At a light load, the reference level control circuit 10a internally generates the voltage VR1 which changes between the signal levels in response to the stop and restart of the switching operation of the switching element 1. The voltage VR1 passes through the low-pass filter 18a and is applied to the non-inverting input terminal of the OP amplifier 5 of the error signal generating circuit 4 as the reference voltage Vref.

The low-pass filter 18a includes a resistor 19a and a capacitor 20a. The resistance value of the resistor 19a and the capacitance of the capacitor 20a are set such that the time constant of the low-pass filter 18a has a sufficiently large value relative to the operating frequency of the auxiliary power supply voltage VCC. The operating frequency of the auxiliary power supply voltage VCC is determined by resistances, capacitances, and inductances which are included in the feedback signal generating circuit 130a and the control circuit 2 and the parasitic resistances, capacitances, and inductances of the feedback signal generating circuit 130a and the control circuit 2. Thus the low-pass filter 18a can cut off a frequency lower than the operating frequency of the auxiliary power supply voltage VCC serving as the feedback signal. Therefore even when the level of the voltage VR1 changes during the intermittent oscillating operation of the switching element 1, the value of the reference voltage Vref is obtained by averaging the voltage VR1, so that the load is stabilized. If intermittent oscillation is performed with a constant period, the reference voltage Vref has a constant value relative to the auxiliary power supply voltage VCC.

As has been discussed, the reference voltage Vref is the mean value of the voltage VR1 at a light load. Thus the longer the switching operation is stopped, that is, the lighter the load, the lower the reference voltage Vref.

In this way the reference level control circuit 10a of FIG. 2 controls the reference level of the auxiliary power supply voltage VCC serving as the feedback signal, that is, the reference voltage Vref applied to the non-inverting input terminal of the OP amplifier 5 according to a time period during which the switching operation of the switching element 1 is stopped.

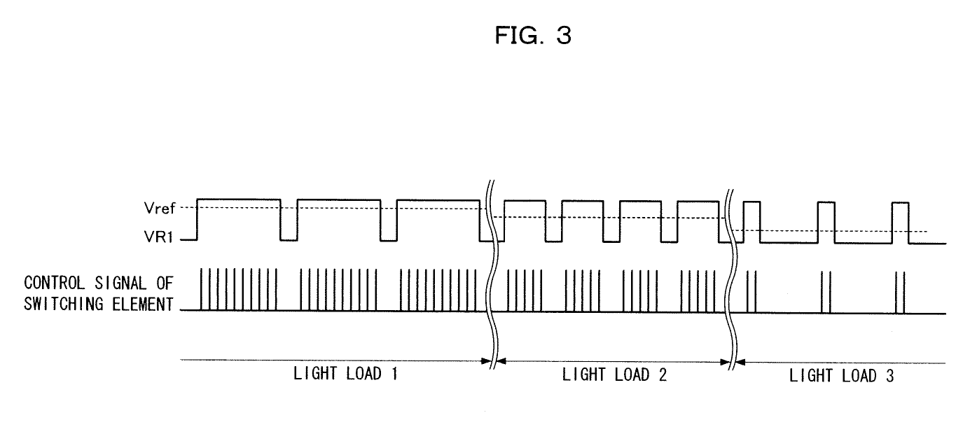

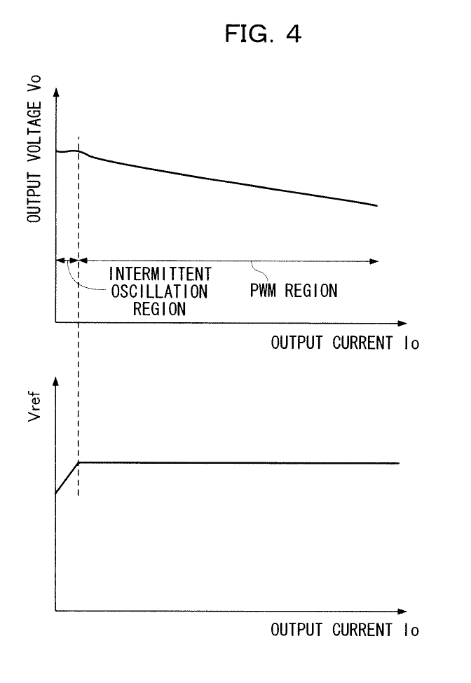

FIG. 3 shows the relationship between the switching operation of the switching element 1 and the voltage VR1 and the reference voltage Vref at a light load. FIG. 4 shows the relationship between an output current Io and the output voltage Vo and the relationship between the output current Io and the reference voltage Vref. As shown in FIGS. 3 and 4, the longer the switching operation is stopped at a light load, that is, as the load and the output current Io decrease, the reference voltage Vref decreases.

The reference level of the feedback signal is controlled thus by the signal generated by the intermittent oscillation control circuit 15 based on the error amplification signal VEAO which is less affected by the delay time and the blanking time of the control circuit, so that as shown in FIG. 4, an increase in the output voltage Vo of the secondary side is suppressed at a light load.

In the foregoing explanation, the voltage VR1 changes between the two levels at a light load. The voltage VR1 may change among at least three levels.

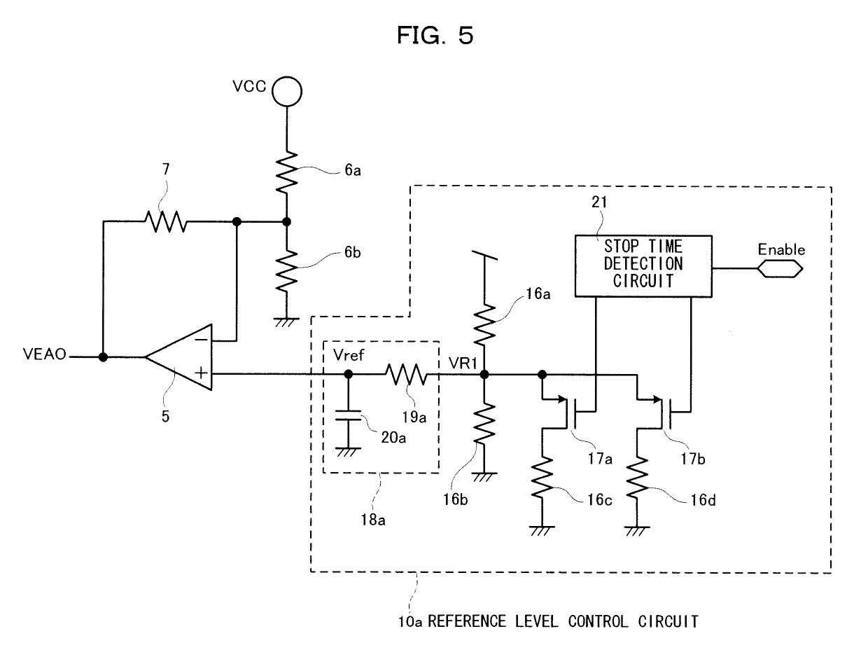

FIG. 5 shows another structural example of the reference level control circuit 10a. Elements corresponding to the elements of FIG. 2 are indicated by the same reference numerals. The reference level control circuit 10a is made up of resistors 16a to 16d, switch elements 17a and 17b, a low-pass filter 18a, and a stop time detection circuit 21.

The resistor 16a and the resistor 16b are connected in series between the power supply line and the ground line of the control circuit 2, and the resistors 16c and 16d are connected in parallel with the resistor 16b via the switch elements 17a and 17b, respectively.

The stop time detection circuit 21 controls the on/off of the switch elements 17a and 17b based on the Enable signal from the intermittent oscillation control circuit 15. Thus the resistance division ratio of the power supply voltage VDD of the control circuit 2 is changed according to a time period during which the switching operation of the switching element 1 is stopped.

To be specific, when the signal level of the Enable signal is High level, the stop time detection circuit 21 turns off the switch elements 17a and 17b. When the signal level of the Enable signal is inverted to Low level, the stop time detection circuit 21 turns on the switch element 17a and keeps the switch element 17b turned off. After a lapse of a predetermined time since the signal level of the Enable signal is inverted to Low level, the stop time detection circuit 21 turns on the switch elements 17a and 17b.

In this case, when the signal level of the Enable signal is High level, the switching operation of the switching element 1 is permitted. When the signal level of the Enable signal is inverted to Low level, the switching operation of the switching element 1 is stopped. When the predetermined time has elapsed since the signal level of the Enable signal is inverted to Low level, the switching operation of the switching element 1 has been stopped for a time period of at least a predetermined value.

With this configuration, when the load decreases and the switching operation of the switching element 1 has been stopped for a time period of at least the predetermined value, the reference level of the feedback signal further decreases. In FIG. 5, the switch elements 17a and 17b are P-type MOSFETs. As a matter of course, the configuration is not limited and the switch elements 17a and 17b may be, for example, N-type MOSFETs.

In the foregoing explanation, the voltage VR1 digitally changes between at least the two levels at a light load. The signal level of the signal supplied to the low-pass filter 18a may change in an analog fashion according to a time period during which the switching operation of the switching element 1 is stopped. The signal changing in an analog fashion can be generated by a time-voltage converter circuit and the like. For example, the time-voltage converter circuit may convert, to an analog voltage signal, a time period during which the switching operation of the switching element 1 is stopped, that is, a period during which the signal level of the Enable signal is Low level.

The foregoing explanation described the configuration in which the auxiliary power supply voltage VCC is generated by rectifying and smoothing the pulse voltage generated on the auxiliary winding T3 of the power conversion transformer 110 and the auxiliary power supply voltage VCC changing in an analog fashion is supplied to one end of the resistor 6a of the error signal generating circuit 4, that is, the opposite terminal from the resistor 6b. In other words, the auxiliary power supply voltage VCC changing in an analog fashion is used as the feedback signal. The feedback signal supplied to one end of the resistor 6a of the error signal generating circuit 4 may be a digitally changing signal.

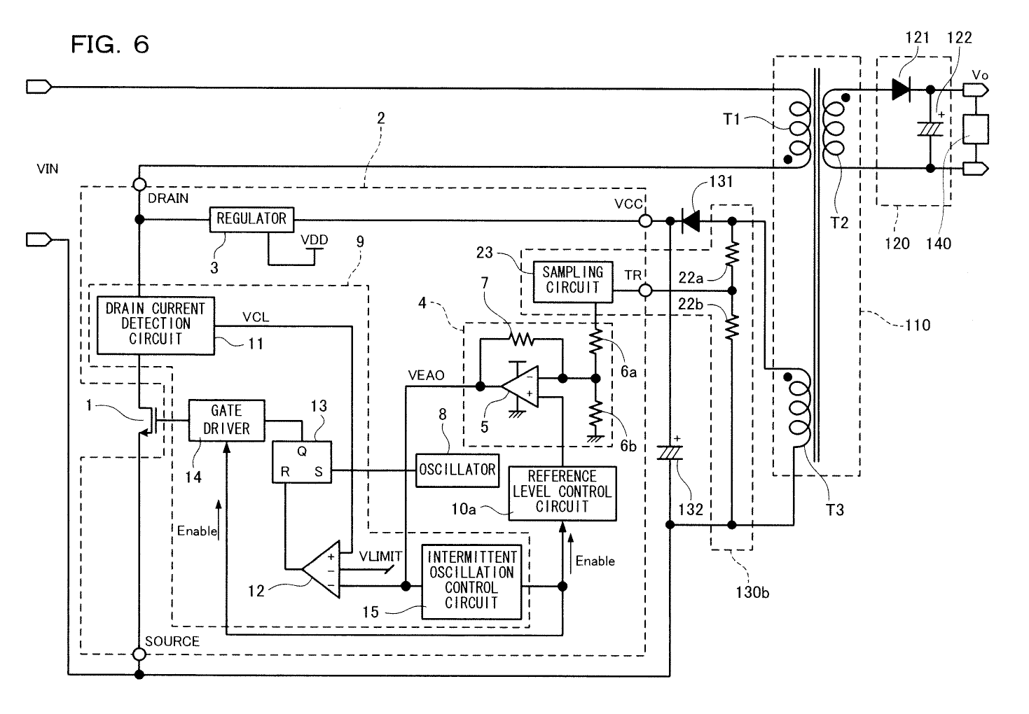

FIG. 6 shows another structural example of the switching power supply according to the first embodiment of the present invention. Elements corresponding to the members of FIG. 1 are indicated by the same reference numerals. A control circuit 2 of the switching power supply has a TR terminal as an external connection terminal in addition to a DRAIN terminal, a VCC terminal, and a SOURCE terminal.

In this switching power supply, the configuration of a feedback signal generating circuit is different from the switching power supply of FIG. 1. To be specific, a feedback signal generating circuit 130b of the switching power supply includes resistors 22a and 22b and a sampling circuit 23. The resistors 22a and 22b are provided for detecting a pulse voltage generated on an auxiliary winding T3 of a power conversion transformer 110. The sampling circuit 23 samples as a feedback signal the voltage value of a pulse voltage having been detected by the resistors 22a and 22b, the voltage value being sampled before the pulse voltage rapidly or substantially perpendicularly decreases. The sampling circuit 23 samples a voltage value every time a pulse voltage is detected by the resistors 22a and 22b.

The resistors 22a and 22b are provided outside the control circuit 2. The resistors 22a and 22b divide the pulse voltage generated on the auxiliary winding T3. The sampling circuit 23 is provided in the control circuit 2. The sampling circuit 23 is connected to the junction point of the resistors 22a and 22b via the TR terminal which is an external connection terminal of the control circuit 2. A voltage held by the sampling circuit 23 is applied to one end of a resistor 6a of an error signal generating circuit 4, that is, the opposite terminal from a resistor 6b. Thus in the error signal generating circuit 4, the voltage held by the sampling circuit 23 is divided by the resistors 6a and 6b and a difference between the divided voltage and a reference voltage Vref is amplified, so that an error amplification signal VEAO is generated.

Thus in the switching power supply, the control circuit 2 generates a control signal applied to the control terminal of a switching element 1, based on the voltage held by the sampling circuit 23. In other words, the voltage held by the sampling circuit 23 is used as a feedback signal.

To the auxiliary winding T3 of the power conversion transformer 110, a rectifying/smoothing circuit made up of a rectifier diode 131 and a smoothing capacitor 132 is connected as in the switching power supply of FIG. 1. The rectifying/smoothing circuit rectifies and smoothes the pulse voltage generated on the auxiliary winding T3, so that an auxiliary power supply voltage VCC is generated. The rectifying/smoothing circuit for generating the auxiliary power supply voltage VCC is connected to the VCC terminal as in the switching power supply of FIG. 1, and the auxiliary power supply voltage VCC is applied to the VCC terminal. In the switching power supply of FIG. 6, the error signal generating circuit 4 is not connected to the VCC terminal and only a regulator 3 is connected to the VCC terminal. Thus in the switching power supply of FIG. 6, the rectifying/smoothing circuit for generating the auxiliary power supply voltage VCC acts only as a circuit current supply circuit.

Further, as in the switching power supply of FIG. 1, a resistor and a capacitor compose a low-pass filter included in a reference level control circuit 10a, and the resistance value of the resistor and the capacitance of the capacitor are set such that the time constant of the low-pass filter has a sufficiently large value relative to the operating frequency of the feedback signal. In this case, the feedback signal is a voltage applied to one end of the resistor 6a from the sampling circuit 23, that is, to the opposite terminal from the resistor 6b. The operating frequency of the feedback signal is determined by resistances, capacitances, and inductances which are included in the feedback signal generating circuit 130b and the control circuit 2 and the parasitic resistances, capacitances, and inductances of the feedback signal generating circuit 130b and the control circuit 2.

### Second Embodiment

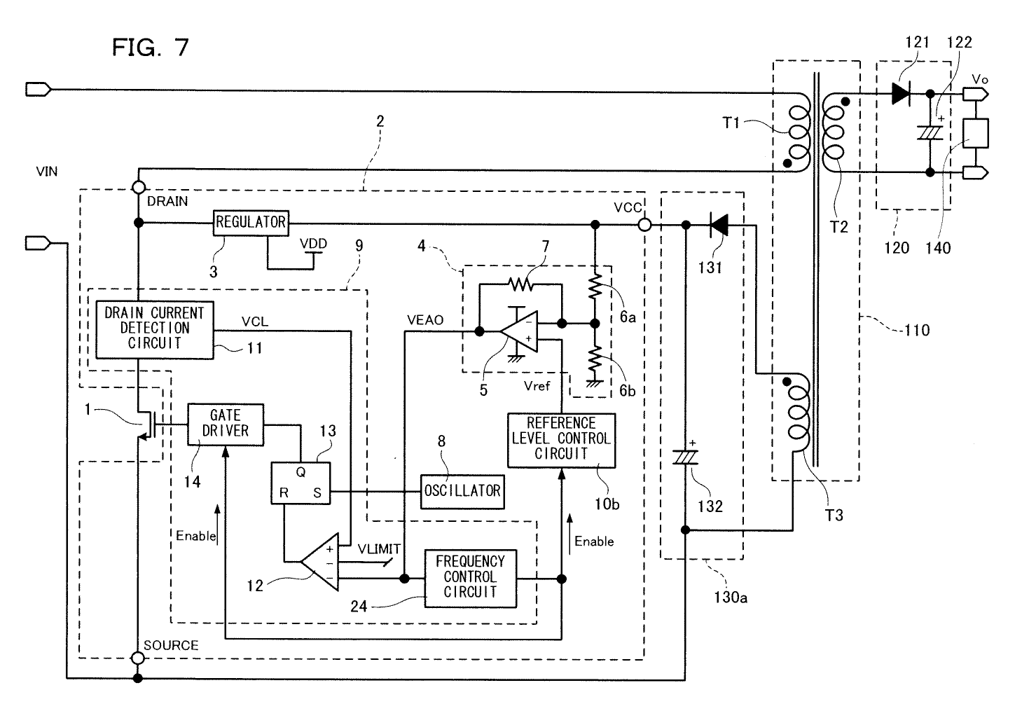

A switching power supply and a semiconductor device for the switching power supply will be described below according to a second embodiment of the present invention. FIG. 7 is a block diagram showing a structural example of the switching power supply according to the second embodiment of the present invention. Elements corresponding to the elements of the first embodiment are indicated by the same reference numerals.

In this switching power supply, the configuration of a control circuit 2 is different from the first embodiment. To be specific, the second embodiment is different from the first embodiment in that a frequency control circuit 24 is provided instead of the intermittent oscillation control circuit. Further, the second embodiment is different from the first embodiment in that PFM control is performed to change the switching frequency of a switching element 1, that is, an oscillatory frequency according to a load. In other words, the switching power supply is a switching power supply of auxiliary winding feedback type for performing PFM control in current mode. Moreover, the second embodiment is different from the first embodiment in that a reference level control circuit 10b controls the reference level of a feedback signal according to the switching frequency of the switching element 1.

The following will mainly describe different points from the first embodiment in detail.

The frequency control circuit 24 generates a signal off_cont whose signal level changes according to the signal level of an error amplification signal VEAO from an error signal generating circuit 4. The signal off_cont controls the switching frequency of the switching element 1. In other words, an oscillator 8 changes the oscillatory frequency according to the signal level of the signal off_cont generated in the frequency control circuit 24. With this configuration, the switching frequency of the switching element 1 is controlled according to a load. To be specific, the lighter the load, the lower the switching frequency of the switching element 1.

Further, the reference level control circuit 10b controls the reference level of an auxiliary power supply voltage VCC serving as a feedback signal, that is, a reference voltage Vref according to the switching frequency of the switching element 1 based on the signal off_cont generated in the frequency control circuit 24. To be specific, the lighter the load and the lower the oscillatory frequency of the switching element 1, the lower the reference voltage Vref. The reference voltage Vref is applied to the non-inverting input terminal of an OP amplifier 5.

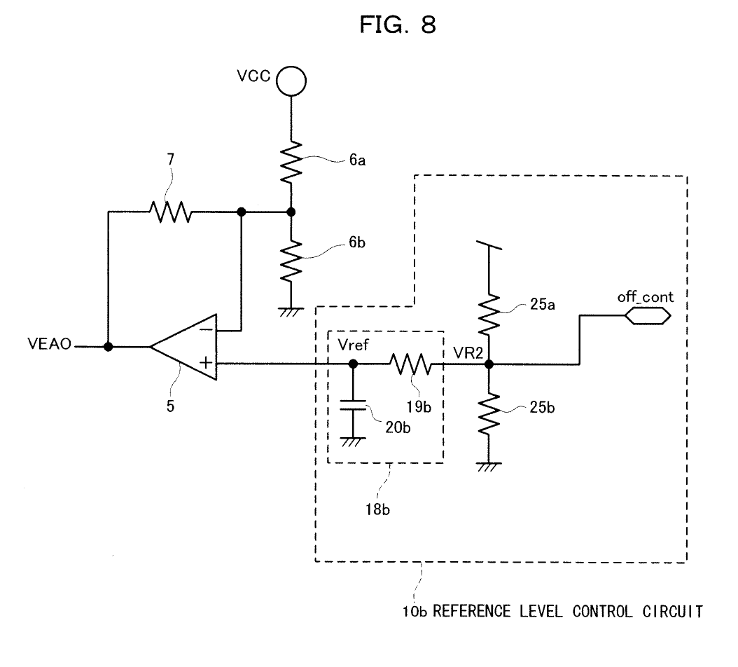

FIG. 8 shows a structural example of the reference level control circuit 10b. In the following explanation, the signal off_cont generated in the frequency control circuit 24 is an analog current signal. The reference level control circuit 10b is made up of resistors 25a and 25b and a low-pass filter 18b. The resistors 25a and 25b are connected in series between the power supply line and the ground line of the control circuit 2. The analog current signal off_cont from the frequency control circuit 24 is supplied to the junction point of the resistors 25a and 25b.

With this configuration, the signal off_cont from the frequency control circuit 24 undergoes I-V conversion and a voltage VR2 is generated on the junction point of the resistors 25a and 25b. The level of the voltage VR2 changes in an analog fashion according to the oscillatory frequency of the switching element 1. To be specific, the lighter the load and the lower the oscillatory frequency of the switching element 1, the lower the voltage VR2. The voltage VR2 generated on the junction point of the resistors 25a and 25b passes through the low-pass filter 18b and is applied as the reference voltage Vref to the non-inverting input terminal of the OP amplifier 5 of the error signal generating circuit 4.

The low-pass filter 18b includes a resistor 19b and a capacitor 20b. The resistance value of the resistor 19b and the capacitance of the capacitor 20b are set such that the time constant of the low-pass filter 18b has a sufficiently large value relative to the operating frequency of the auxiliary power supply voltage VCC serving as the feedback signal. The operating frequency of the auxiliary power supply voltage VCC is determined by resistances, capacitances, and inductances which are included in a feedback signal generating circuit 130a and the control circuit 2 and the parasitic resistances, capacitances, and inductances of the feedback signal generating circuit 130a and the control circuit 2. With this configuration, the low-pass filter 18b can cut off a frequency lower than the operating frequency of the auxiliary power supply voltage VCC serving as the feedback signal. Thus even when the level of the voltage VR2 changes according to a load, the reference voltage Vref has a value obtained by averaging the voltage VR2, so that the reference voltage Vref has a constant value relative to the auxiliary power supply voltage VCC when the load is stabilized.

As has been discussed, the value of the reference voltage Vref is the mean value of the voltage VR2. Thus the lower the switching frequency of the switching element 1, that is, the lighter the load, the lower the reference voltage Vref.

Therefore, even in the switching power supply which reduces the switching frequency of the switching element 1 at a light load to reduce power consumption, the reference level of the auxiliary power supply voltage VCC serving as the feedback signal, that is, the reference voltage Vref is controlled according to the switching frequency, thereby suppressing an increase in output voltage at a light load.

In the foregoing configuration, the auxiliary power supply voltage VCC changing in an analog fashion is used as the feedback signal. As in the first embodiment, a digitally changing feedback signal may be supplied to one end of a resistor 6a of the error signal generating circuit 4, that is, the opposite terminal from a resistor 6b. To be specific, for example, the following configuration may be used: a pulse voltage generated on an auxiliary winding T3 is detected by a resistor, the voltage value of the detected pulse voltage is sampled by a sampling circuit as a feedback signal before the pulse voltage rapidly or substantially perpendicularly decreases, and the voltage held by the sampling circuit is applied to one end of the resistor 6a of the error signal generating circuit 4.

### Third Embodiment

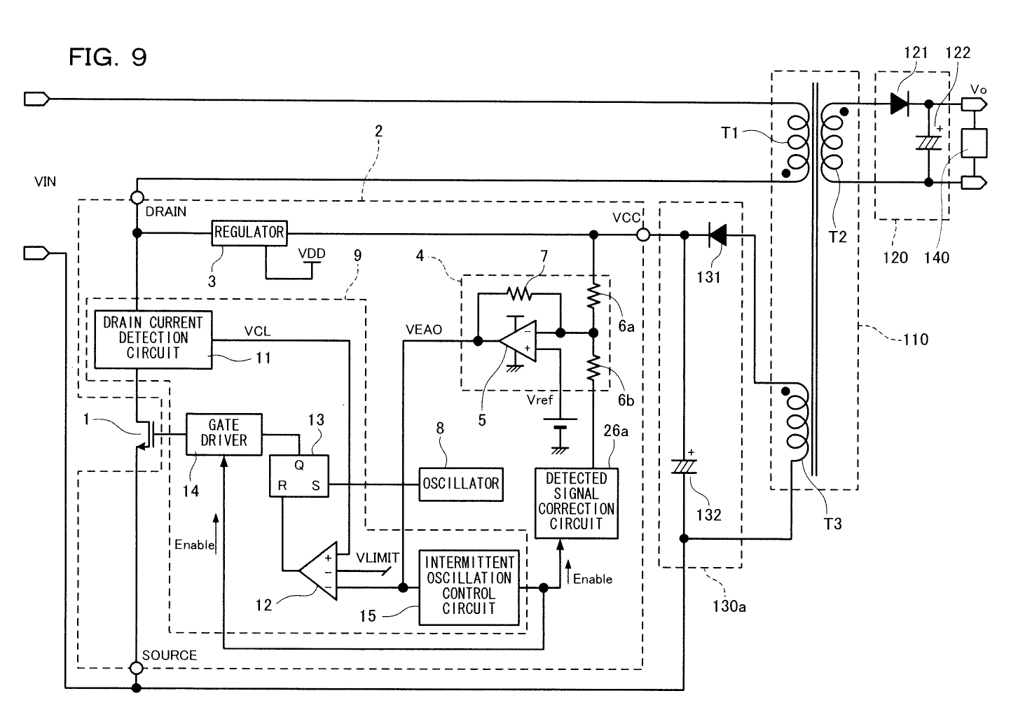

A switching power supply and a semiconductor device for the switching power supply will be described below according to a third embodiment of the present invention. FIG. 9 is a block diagram showing a structural example of the switching power supply according to the third embodiment of the present invention. Elements corresponding to the elements of the first embodiment are indicated by the same reference numerals.

In this switching power supply, the configuration of a control circuit 2 is different from the first embodiment. To be specific, the third embodiment is different from the first embodiment in that a detected signal correction circuit 26a is provided instead of the reference level control circuit.

The first embodiment controls the reference level of the feedback signal, that is, the reference voltage Vref applied to the non-inverting input terminal of the OP amplifier included in the error signal generating circuit, whereas the third embodiment corrects the detection level of a feedback signal in an error signal generating circuit 4, that is, a voltage applied to the inverting input terminal of an OP amplifier 5 included in the error signal generating circuit 4. The correction is made by the detected signal correction circuit 26a.

The following will mainly describe different points from the first embodiment in detail.

The detected signal correction circuit 26a corrects the detection level of an auxiliary power supply voltage VCC serving as the feedback signal, that is, the voltage applied to the inverting input terminal of the OP amplifier 5, based on an Enable signal from an intermittent oscillation control circuit 15 according to a time period during which the switching operation of a switching element 1 is stopped.

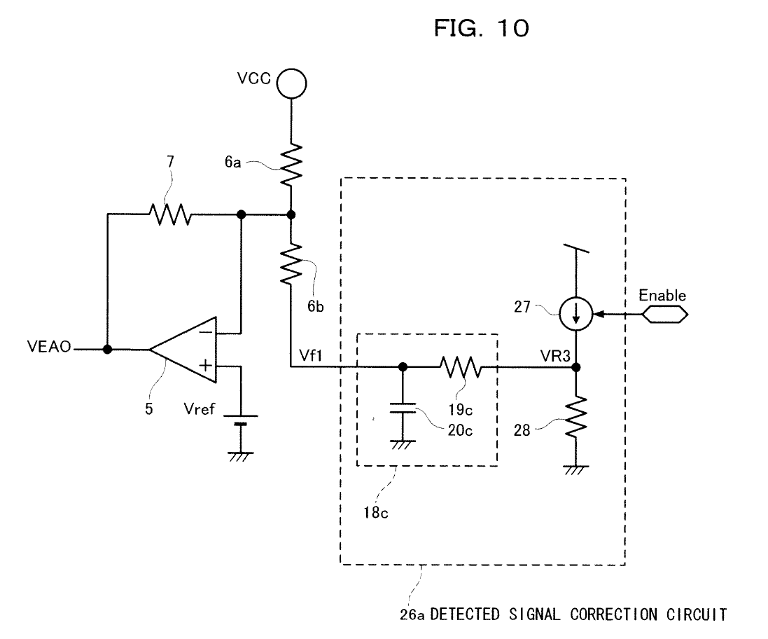

FIG. 10 shows a structural example of the detected signal correction circuit 26a. The detected signal correction circuit 26a is made up of a constant current source 27, a resistor 28, and a low-pass filter 18c. The constant current source 27 and the resistor 28 are connected in series and the junction point of the constant current source 27 and the resistor 28 is connected to one end of a resistor 6b included in the error signal generating circuit 4, that is, the opposite terminal from a resistor 6a via the low-pass filter 18c.

The Enable signal from the intermittent oscillation control circuit 15 is supplied to the constant current source 27. The constant current supply operation of the constant current source 27 is controlled by the Enable signal from the intermittent oscillation control circuit 15.

In the following explanation, as in the first embodiment, the signal level of the Enable signal is set at Low level when the intermittent oscillation control circuit 15 stops the switching operation of the switching element 1, and the signal level of the Enable signal is set at High level when the intermittent oscillation control circuit 15 permits the switching operation of the switching element 1.

In this case, the constant current source 27 generates a constant current when the signal level of the Enable signal is High level, that is, when the switching element 1 performs the switching operation. The constant current source 27 does not generate a constant current when the signal level of the Enable signal is Low level, that is, when the switching operation of the switching element 1 is stopped.

Thus the signal level of the Enable signal changes between High level and Low level at a light load, so that a voltage VR3 generated on the junction point of the constant current source 27 and the resistor 28 changes between the two levels, accordingly. To be specific, the voltage VR3 with the Enable signal at Low level is lower than the voltage VR3 with the Enable signal at High level. In normal PWM control, the signal level of the Enable signal is kept at High level and thus the voltage VR3 is also kept at a constant value.

In this way the detected signal correction circuit 26a internally generates the voltage VR3 kept at the constant value in normal PWM control. At a light load, the detected signal correction circuit 26a internally generates the voltage VR3 whose signal level changes in response to the stop and restart of the switching operation of the switching element 1. The voltage VR3 passes through the low-pass filter 18c and is applied to one end of the resistor 6b, that is, the opposite terminal from the resistor 6a.

The low-pass filter 18c includes a resistor 19c and a capacitor 20c. The resistance value of the resistor 19c and the capacitance of the capacitor 20c are set such that the time constant of the low-pass filter 18c has a sufficiently large value relative to the operating frequency of the auxiliary power supply voltage VCC serving as the feedback signal. The operating frequency of the auxiliary power supply voltage VCC is determined by resistances, capacitances, and inductances which are included in a feedback signal generating circuit 130a and the control circuit 2 and the parasitic resistances, capacitances, and inductances of the feedback signal generating circuit 130a and the control circuit 2. With this configuration, the low-pass filter 18c can cut off a frequency lower than the operating frequency of the auxiliary power supply voltage VCC serving as the feedback signal. Thus even when the level of the voltage VR3 changes during the intermittent oscillating operation of the switching element 1, a voltage Vf1 applied to one end of the resistor 6b, that is, the opposite terminal from the resistor 6a has a value obtained by averaging the voltage VR3. When the load is stabilized and intermittent oscillation is performed with a constant period, the voltage Vf1 has a constant value relative to the auxiliary power supply voltage VCC.

As has been discussed, the value of the voltage Vf1 is the mean value of the voltage VR3. Thus the longer the switching operation is stopped, that is, the lighter the load, the lower the voltage Vf1. Thus as the load decreases, the detected signal correction circuit 26a reduces the voltage applied to the inverting input terminal of the OP amplifier 5 to increase an error amplification signal VEAO and shortens a time period during which the switching operation of the switching element 1 is stopped. It is therefore possible to suppress an increase in output voltage Vo at a light load. In this case, the voltage applied to the inverting input terminal of the OP amplifier 5 is the detection level of the feedback signal.

The detection level of the feedback signal in the error signal generating circuit 4 is corrected thus by the signal generated by the intermittent oscillation control circuit 15 based on the error amplification signal VEAO which is less affected by the delay time and blanking time of the control circuit, thereby suppressing an increase in the output voltage Vo of the secondary side at a light load.

In the foregoing explanation, the voltage VR3 changes between the two levels at a light load. The voltage VR3 may change among at least three levels as in the first embodiment. For example, as a configuration for generating the voltage VR3 changing among three levels, two constant current sources connected to a resistor may be disposed in parallel and a circuit may be provided for controlling the constant current supply operation of the constant current sources based on the Enable signal from the intermittent oscillation control circuit 15. The circuit for controlling the constant current supply operation of the constant current sources is preferably configured such that constant currents are generated from the two constant current sources when the signal level of the Enable signal is High level, a constant current is generated from only one of the constant current sources when the signal level of the Enable signal is inverted to Low level, and the two constant current sources do not generate any constant currents after a lapse of a predetermined time since the signal level of the Enable signal is inverted to Low level.

When the signal level of the Enable signal is High level, the switching operation of the switching element 1 is permitted. When the signal level of the Enable signal is inverted to Low level, the switching operation of the switching element 1 is stopped. When the predetermined time has elapsed since the signal level of the Enable signal is inverted to Low level, the switching operation of the switching element 1 has been stopped for a time period of at least a predetermined value.

In the foregoing explanation, the voltage VR3 digitally changes between at least the two levels at a light load. The signal level of the signal supplied to the low-pass filter 18c may change in an analog fashion according to a time period during which the switching operation of the switching element 1 is stopped. The signal changing in an analog fashion can be generated by a time-voltage converter circuit and the like. For example, the time-voltage converter circuit may convert, to an analog voltage signal, a period during which the signal level of the Enable signal is Low level.

In the foregoing configuration, the auxiliary power supply voltage VCC changing in an analog fashion is used as the feedback signal. As in the first embodiment, a digitally changing feedback signal may be supplied to one end of the resistor 6a of the error signal generating circuit 4, that is, the opposite terminal from the resistor 6b. To be specific, for example, the following configuration may be used: a pulse voltage generated on an auxiliary winding T3 is detected by a resistor, the voltage value of the detected pulse voltage is sampled by a sampling circuit as a feedback signal before the pulse voltage rapidly or substantially perpendicularly decreases, and the voltage held by the sampling circuit is applied to one end of the resistor 6a of the error signal generating circuit 4.

### Fourth Embodiment

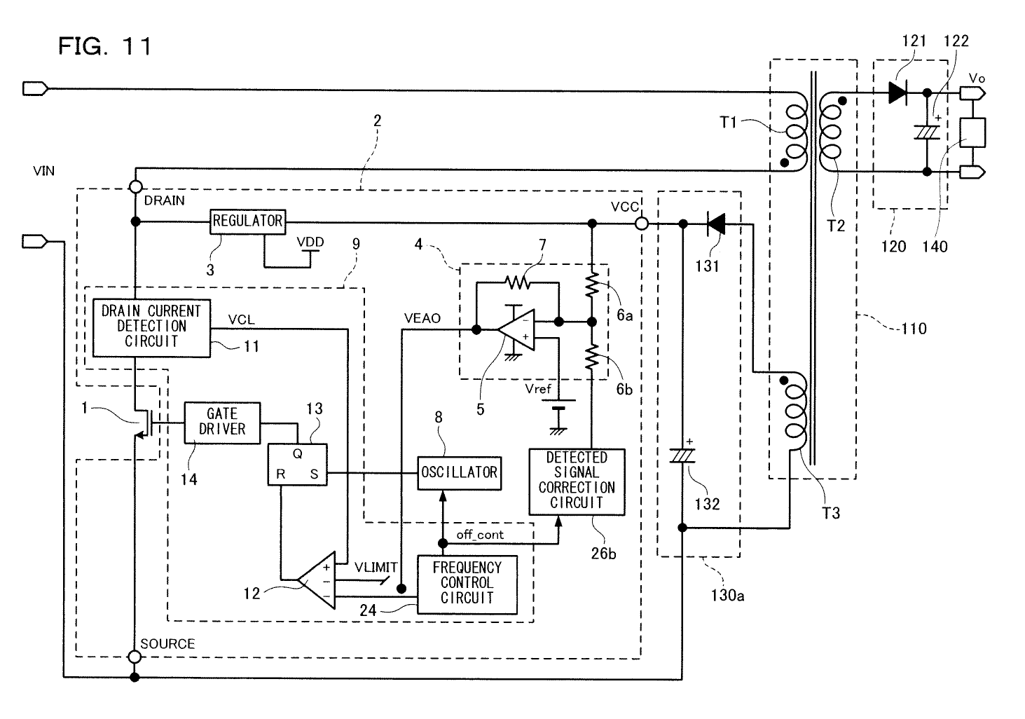

A switching power supply and a semiconductor device for the switching power supply will be described below according to a fourth embodiment of the present invention. FIG. 11 is a block diagram showing a structural example of the switching power supply according to the fourth embodiment of the present invention. Elements corresponding to the elements of the first to third embodiments are indicated by the same reference numerals.

In this switching power supply, the configuration of a control circuit 2 is different from the third embodiment. To be specific, the fourth embodiment is different from the third embodiment in that a frequency control circuit 24 is provided instead of the intermittent oscillation control circuit. Further, the fourth embodiment is different from the third embodiment in that PFM control is performed to change the switching frequency of a switching element 1, that is, an oscillatory frequency according to a load. In other words, the switching power supply is a switching power supply of auxiliary winding feedback type for performing PFM control in current mode. Moreover, the fourth embodiment is different from the third embodiment in that a detected signal correction circuit 26b corrects the detection level of a feedback signal in an error signal generating circuit 4 according to the switching frequency of the switching element 1.

The following will mainly describe different points from the third embodiment in detail.

The detected signal correction circuit 26b corrects the detection level of an auxiliary power supply voltage VCC serving as the feedback signal, that is, a voltage applied to the inverting input terminal of an OP amplifier 5, according to the switching frequency of the switching element 1 based on a signal off_cont generated in the frequency control circuit 24.

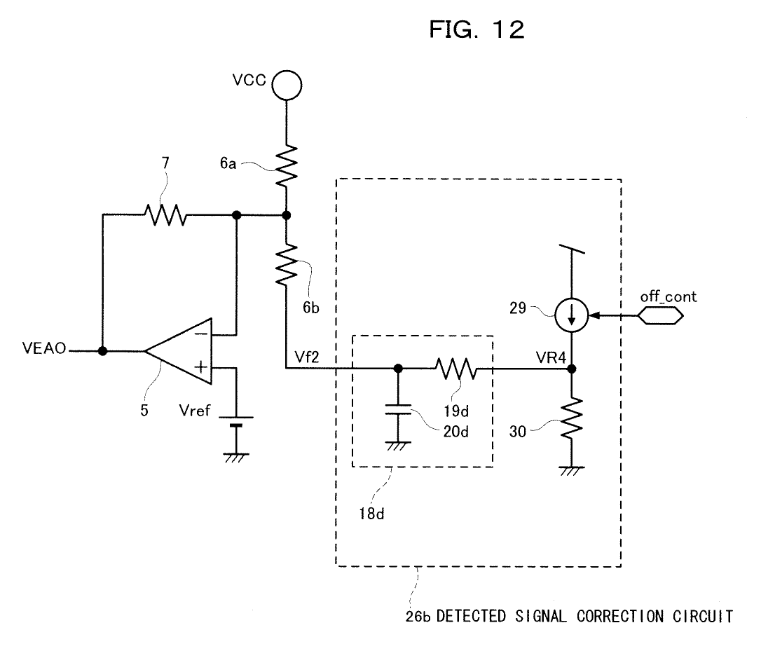

FIG. 12 shows a structural example of the detected signal correction circuit 26b. In the following explanation, the signal off_cont generated in the frequency control circuit 24 is an analog current signal as in the second embodiment.

The detected signal correction circuit 26b is made up of a constant current source 29, a resistor 30, and a low-pass filter 18d. The constant current source 29 and the resistor 30 are connected in series and the junction point of the constant current source 29 and the resistor 30 is connected to one end of a resistor 6b included in the error signal generating circuit 4, that is, the opposite terminal from a resistor 6a via the low-pass filter 18d.

The analog current signal off_cont from the frequency control circuit 24 is supplied to the constant current source 29. The constant current source 29 changes the current value of constant current according to the current value of the analog current signal off_cont from the frequency control circuit 24.

With this configuration, a voltage VR4 is generated on the junction point of the constant current source 29 and the resistor 30. The level of the voltage VR4 changes in an analog fashion according to the signal level of the signal off_cont from the frequency control circuit 24, that is, the oscillatory frequency of the switching element 1. To be specific, the lighter the load and the lower the oscillatory frequency of the switching element 1, the lower the voltage VR4. The voltage VR4 generated on the junction point of the constant current source 29 and the resistor 30 passes through the low-pass filter 18d and is applied to one end of the resistor 6b, that is, the opposite terminal from the resistor 6a.

The low-pass filter 18d includes a resistor 19d and a capacitor 20d. The resistance value of the resistor 19b and the capacitance of the capacitor 20d are set such that the time constant of the low-pass filter 18d has a sufficiently large value relative to the operating frequency of the auxiliary power supply voltage VCC serving as the feedback signal. The operating frequency of the auxiliary power supply voltage VCC is determined by resistances, capacitances, and inductances which are included in a feedback signal generating circuit 130a and the control circuit 2 and the parasitic resistances, capacitances, and inductances of the feedback signal generating circuit 130a and the control circuit 2. With this configuration, the low-pass filter 18d can cut off a frequency lower than the operating frequency of the auxiliary power supply voltage VCC serving as the feedback signal. Thus even when the level of the voltage VR4 changes according to a load, a voltage Vf2 applied to one end of the resistor 6b, that is, the opposite terminal from the resistor 6a has a value obtained by averaging the voltage VR4, so that the voltage Vf2 has a constant value relative to the auxiliary power supply voltage VCC when the load is stabilized.

As has been discussed, the value of the voltage Vf2 is the mean value of the voltage VR4. Thus the lower the switching frequency of the switching element 1, that is, the lighter the load, the lower the voltage Vf2.

Therefore, even in the switching power supply which reduces the switching frequency of the switching element 1 at a light load to reduce power consumption, the detection level of the auxiliary power supply voltage VCC serving as the feedback signal, that is, a voltage applied to the non-inverting input terminal of the OP amplifier 5 is corrected according to the switching frequency, thereby suppressing an increase in output voltage at a light load.

In the foregoing explanation, the auxiliary power supply voltage VCC changing in an analog fashion is used as the feedback signal. As in the first embodiment, a digitally changing feedback signal may be supplied to one end of the resistor 6a of the error signal generating circuit 4, that is, the opposite terminal from the resistor 6b.

To be specific, for example, the following configuration may be used: a pulse voltage generated on an auxiliary winding T3 is detected by a resistor, the voltage value of the detected pulse voltage is sampled by a sampling circuit as a feedback signal before the pulse voltage rapidly or substantially perpendicularly decreases, and the voltage held by the sampling circuit is applied to one end of the resistor 6a of the error signal generating circuit 4.

According to the foregoing first to fourth embodiments, the semiconductor device for the switching power supply has the control circuit 2 formed on the same semiconductor substrate. The semiconductor device for the switching power supply may have the switching element 1 and the control circuit 2 formed on the same semiconductor substrate. Further, although the control circuit 2 has the three external connection terminals (DRAIN terminal, VCC terminal, SOURCE terminal) or the four external connection terminals (DRAIN terminal, VCC terminal, SOURCE terminal, TR terminal), the control circuit 2 may of course include other terminals.

What is claimed is:

1. A switching power supply comprising:
a transformer having a primary winding, a secondary winding, and an auxiliary winding, the primary winding being fed with a first DC voltage;
a switching element connected to the primary winding to generate voltages on the secondary winding and the auxiliary winding by a switching operation;
an output voltage generating circuit for generating a second DC voltage from the voltage generated on the secondary winding;
a feedback signal generating circuit for generating a feedback signal from the voltage generated on the auxiliary winding;
an oscillator circuit for oscillating a signal for turning on the switching element;
an error signal generating circuit for detecting a signal level of the feedback signal and generating an error signal having a signal level corresponding to a difference between the detected signal level and a reference level;
a switching control circuit for turning on the switching element at a time in response to the signal oscillated by the oscillator circuit and turning off the switching element at a time in response to the signal level of the error signal; and
a reference level control circuit for controlling the reference level according to one of a time period during which the switching operation of the switching element is stopped and a switching frequency of the switching element.

2. The switching power supply according to claim 1, wherein the reference level control circuit internally generates a signal changing between at least two levels.

3. The switching power supply according to claim 1, wherein the reference level control circuit comprises a low-pass filter for cutting off a frequency lower than an operating frequency of the feedback signal.

4 The switching power supply according to claim 1, wherein the switching control circuit comprises an intermittent oscillation control circuit for controlling stop and restart of the switching operation of the switching element according to the signal level of the error signal, and the reference level control circuit controls the reference level based on a signal from the intermittent oscillation control circuit according to the time period during which the switching operation of the switching element is stopped.

5. The switching power supply according to claim 1, wherein the switching control circuit comprises a frequency control circuit for controlling the switching frequency of the switching element according to the signal level of the error signal, and the reference level control circuit controls the reference level based on a signal from the frequency control circuit according to the switching frequency of the switching element.

6. The switching power supply according to claim 1, wherein the feedback signal generating circuit comprises a rectifier diode and a smoothing capacitor, and the feedback signal is generated by the rectifier diode and the smoothing capacitor which rectify and smooth the voltage generated on the auxiliary winding.

7. The switching power supply according to claim 1, wherein the feedback signal generating circuit comprises a resistor for detecting the voltage generated on the auxiliary winding, and a sampling circuit for sampling a voltage value of the voltage as the feedback signal before the voltage detected by the resistor rapidly decreases.

8. The switching power supply according to claim 6, further comprising a semiconductor device having at least three external connection terminals and a semiconductor substrate,
wherein the switching element, the oscillator circuit, the error signal generating circuit, the switching control circuit, and the reference level control circuit are formed on the semiconductor substrate, or the oscillator circuit, the error signal generating circuit, the switching control circuit, and the reference level control circuit are formed on the semiconductor substrate.

9. The switching power supply according to claim 7, further comprising a semiconductor device having at least four external connection terminals and a semiconductor substrate,
wherein the switching element, the oscillator circuit, the error signal generating circuit, the switching control circuit, the reference level control circuit, and the sampling circuit of the feedback signal generating circuit are formed on the semiconductor substrate, or the oscillator circuit, the error signal generating circuit, the switching control circuit, the reference level control circuit, and the sampling circuit of the feedback signal generating circuit are formed on the semiconductor substrate.

10. A switching power supply comprising:
a transformer having a primary winding, a secondary winding, and an auxiliary winding, the primary winding being fed with a first DC voltage;
a switching element connected to the primary winding to generate voltages on the secondary winding and the auxiliary winding by a switching operation;
an output voltage generating circuit for generating a second DC voltage from the voltage generated on the secondary winding;
a feedback signal generating circuit for generating a feedback signal from the voltage generated on the auxiliary winding;
an oscillator circuit for oscillating a signal for turning on the switching element;
an error signal generating circuit for detecting a signal level of the feedback signal and generating an error signal having a signal level corresponding to a difference between the detected signal level and a reference level;
a switching control circuit for turning on the switching element at a time in response to the signal oscillated by the oscillator circuit and turning off the switching element at a time in response to the signal level of the error signal; and
a correction circuit for correcting the detected level of the feedback signal in the error signal generating circuit according to one of a time period during which the switching operation of the switching element is stopped and a switching frequency of the switching element.

11. The switching power supply according to claim 10, wherein the correction circuit comprises a low-pass filter for cutting off a frequency lower than an operating frequency of the feedback signal.

12. The switching power supply according to claim 10, wherein the switching control circuit comprises an intermittent oscillation control circuit for controlling stop and restart of the switching operation of the switching element according to the signal level of the error signal, and the correction circuit corrects the detected level of the feedback signal in the error signal generating circuit based on a signal from the intermittent oscillation control circuit according to the time period during which the switching operation of the switching element is stopped.

13. The switching power supply according to claim 10, wherein the switching control circuit comprises a frequency control circuit for controlling the switching frequency of the switching element according to the signal level of the error signal, and the correction circuit corrects the detected level of the feedback signal in the error signal generating circuit based on a signal from the frequency control circuit according to the switching frequency of the switching element.

14. The switching power supply according to claim 10, wherein the feedback signal generating circuit comprises a rectifier diode and a smoothing capacitor and the feedback signal is generated by the rectifier diode and the smoothing capacitor which rectify and smooth the voltage generated on the auxiliary winding.

15. The switching power supply according to claim 10, wherein the feedback signal generating circuit comprises a resistor for detecting the voltage generated on the auxiliary winding, and a sampling circuit for sampling a voltage value of the voltage as the feedback signal before the voltage detected by the resistor rapidly decreases.

16. The switching power supply according to claim 14, further comprising a semiconductor device having at least three external connection terminals and a semiconductor substrate,
wherein the switching element, the oscillator circuit, the error signal generating circuit, the switching control circuit, and the correction circuit are formed on the semiconductor substrate, or the oscillator circuit, the error signal generating circuit, the switching control circuit, and the correction circuit are formed on the semiconductor substrate.

17. The switching power supply according to claim 15, further comprising a semiconductor device having at least four external connection terminals and a semiconductor substrate,
wherein the switching element, the oscillator circuit, the error signal generating circuit, the switching control circuit, the correction circuit, and the sampling circuit of the feedback signal generating circuit are formed on the semiconductor substrate, or the oscillator circuit, the error signal generating circuit, the switching control circuit, the correction circuit, and the sampling circuit of the feedback signal generating circuit are formed on the semiconductor substrate.

18. A semiconductor device for a switching power supply, comprising:
a switching element which is connected to a primary winding of a transformer fed with a DC voltage and generates voltages on a secondary winding and an auxiliary winding of the transformer by a switching operation; and
a control circuit for controlling the switching operation of the switching element based on a feedback signal generated from the voltage generated on the auxiliary winding,
the control circuit comprising:
an oscillator circuit for oscillating a signal for turning on the switching element;
an error signal generating circuit for detecting a signal level of the feedback signal and generating an error signal having a signal level corresponding to a difference between the detected signal level and a reference level;
a switching control circuit for turning on the switching element at a time in response to the signal oscillated by the oscillator circuit and turning off the switching element at a time in response to the signal level of the error signal; and
a reference level control circuit for controlling the reference level according to one of a time period during which the switching operation of the switching element is stopped and a switching frequency of the switching element.

19. The semiconductor device for a switching power supply according to claim 18, wherein the reference level control circuit internally generates a signal changing between at least two levels.

20. The semiconductor device for a switching power supply according to claim 18, wherein the reference level control circuit comprises a low-pass filter for cutting off a frequency lower than an operating frequency of the feedback signal.

21. The semiconductor device for a switching power supply according to claim 18, wherein the switching control circuit comprises an intermittent oscillation control circuit for controlling stop and restart of the switching operation of the switching element according to the signal level of the error signal, and the reference level control circuit controls the reference level based on a signal from the intermittent oscillation control circuit according to the time period during which the switching operation of the switching element is stopped.

22. The semiconductor device for a switching power supply according to claim 18, wherein the switching control circuit comprises a frequency control circuit for controlling the switching frequency of the switching element according to the signal level of the error signal, and the reference level control circuit controls the reference level based on a signal from the frequency control circuit according to the switching frequency of the switching element.

23. The semiconductor device for a switching power supply according to claim 18, wherein the control circuit further comprises a sampling circuit for sampling a voltage value of the voltage generated on the auxiliary winding and detected by an external resistor, as the feedback signal before the voltage rapidly decreases.

24. A semiconductor device for a switching power supply, comprising:
a switching element which is connected to a primary winding of a transformer fed with a DC voltage and generates voltages on a secondary winding and an auxiliary winding of the transformer by a switching operation; and
a control circuit for controlling the switching operation of the switching element based on a feedback signal generated from the voltage generated on the auxiliary winding,
the control circuit comprising:
an oscillator circuit for oscillating a signal for turning on the switching element;
an error signal generating circuit for detecting a signal level of the feedback signal and generating an error signal having a signal level corresponding to a difference between the detected signal level and a reference level;
a switching control circuit for turning on the switching element at a time in response to the signal oscillated by the oscillator circuit and turning off the switching element at a time in response to the signal level of the error signal; and
a correction circuit for correcting the detected level of the feedback signal in the error signal generating circuit according to one of a time period during which the switching operation of the switching element is stopped and a switching frequency of the switching element.

25. The semiconductor device for a switching power supply according to claim 24, wherein the correction circuit comprises a low-pass filter for cutting off a frequency lower than an operating frequency of the feedback signal.

26. The semiconductor device for a switching power supply according to claim 24, wherein the switching control circuit comprises an intermittent oscillation control circuit for controlling stop and restart of the switching operation of the switching element according to the signal level of the error signal, and the correction circuit corrects the detected level of the feedback signal in the error signal generating circuit based on a signal from the intermittent oscillation control circuit according to the time period during which the switching operation of the switching element is stopped.

27. The semiconductor device for a switching power supply according to claim 24, wherein the switching control circuit comprises a frequency control circuit for controlling the switching frequency of the switching element according to the signal level of the error signal, and the correction circuit corrects the detected level of the feedback signal in the error signal generating circuit based on a signal from the frequency control circuit according to the switching frequency of the switching element.

28. The semiconductor device for a switching power supply according to claim 24, wherein the control circuit further comprises a sampling circuit for sampling a voltage value of the voltage generated on the auxiliary winding and detected by an external resistor, as the feedback signal before the voltage rapidly decreases.

29. A semiconductor device for a switching power supply, comprising a control circuit which is connected to a primary winding of a transformer fed with a DC voltage and controls a switching operation of a switching element for generating voltages on a secondary winding and an auxiliary winding of the transformer by the switching operation, the switching operation being controlled based on a feedback signal generated from the voltage generated on the auxiliary winding of the transformer,
the control circuit comprising:
an oscillator circuit for oscillating a signal for turning on the switching element;
an error signal generating circuit for detecting a signal level of the feedback signal and generating an error signal having a signal level corresponding to a difference between the detected signal level and a reference level;
a switching control circuit for turning on the switching element at a time in response to the signal oscillated by the oscillator circuit and turning off the switching element at a time in response to the signal level of the error signal; and
a reference level control circuit for controlling the reference level according to one of a time period during which the switching operation of the switching element is stopped and a switching frequency of the switching element.

30. The semiconductor device for a switching power supply according to claim 29, wherein the reference level control circuit internally generates a signal changing between at least two levels.

31. The semiconductor device for a switching power supply according to claim 29, wherein the reference level control circuit comprises a low-pass filter for cutting off a frequency lower than an operating frequency of the feedback signal.

32. The semiconductor device for a switching power supply according to claim 29, wherein the switching control circuit comprises an intermittent oscillation control circuit for controlling stop and restart of the switching operation of the switching element according to the signal level of the error signal, and the reference level control circuit controls the reference level based on a signal from the intermittent oscillation control circuit according to the time period during which the switching operation of the switching element is stopped.

33. The semiconductor device for a switching power supply according to claim 29, wherein the switching control circuit comprises a frequency control circuit for controlling the switching frequency of the switching element according to the signal level of the error signal, and the reference level control circuit controls the reference level based on a signal from the frequency control circuit according to the switching frequency of the switching element.

34. The semiconductor device for a switching power supply according to claim 29, wherein the control circuit further comprises a sampling circuit for sampling a voltage value of the voltage generated on the auxiliary winding and detected by an external resistor, as the feedback signal before the voltage rapidly decreases.

35. A semiconductor device for a switching power supply, comprising a control circuit which is connected to a primary winding of a transformer fed with a DC voltage and controls a switching operation of a switching element for generating voltages on a secondary winding and an auxiliary winding of the transformer by the switching operation, the switching operation being controlled based on a feedback signal generated from the voltage generated on the auxiliary winding of the transformer,
the control circuit comprising:
an oscillator circuit for oscillating a signal for turning on the switching element;
an error signal generating circuit for detecting a signal level of the feedback signal and generating an error signal having a signal level corresponding to a difference between the detected signal level and a reference level;
a switching control circuit for turning on the switching element at a time in response to the signal oscillated by the oscillator circuit and turning off the switching element at a time in response to the signal level of the error signal; and
a correction circuit for correcting the detected level of the feedback signal in the error signal generating circuit according to one of a time period during which the switching operation of the switching element is stopped and a switching frequency of the switching element.

36. The semiconductor device for a switching power supply according to claim 35, wherein the correction circuit comprises a low-pass filter for cutting off a frequency lower than an operating frequency of the feedback signal.

37. The semiconductor device for a switching power supply according to claim 35, wherein the switching control circuit comprises an intermittent oscillation control circuit for controlling stop and restart of the switching operation of the switching element according to the signal level of the error signal, and the correction circuit corrects the detected level of the feedback signal in the error signal generating circuit based on a signal from the intermittent oscillation control circuit according to the time period during which the switching operation of the switching element is stopped.

38. The semiconductor device for a switching power supply according to claim 35, wherein the switching control circuit comprises a frequency control circuit for controlling the switching frequency of the switching element according to the signal level of the error signal, and the correction circuit corrects the detected level of the feedback signal in the error signal generating circuit based on a signal from the frequency control circuit according to the switching frequency of the switching element.

39. The semiconductor device for a switching power supply according to claim 35, wherein the control circuit further comprises a sampling circuit for sampling a voltage value of the voltage generated on the auxiliary winding and detected by an external resistor, as the feedback signal before the voltage rapidly decreases.
